(19) United States
(12) Patent Application Publication
(10) Pub. No.: US 2015/0039549 A1
(43) Pub. Date: Feb. 5, 2015

(54) SYSTEM AND METHOD FOR COMPUTERIZED RECOMMENDATION DELIVERY, TRACKING, AND PRIORITIZATION

(71) Applicant: Reccosend LLC, Park Ridge, IL (US)

(72) Inventors: Charles E. Aufmann, Park Ridge, IL (US); John Gillotte, Chicago, IL (US)

(21) Appl. No.: 14/447,586

(22) Filed: Jul. 30, 2014

Related U.S. Application Data
(60) Provisional application No. 61/859,970, filed on Jul. 30, 2013.

(51) Int. Cl. G06N 5/04; G06F 17/30; H04L 29/08

(52) U.S. Cl. CPC G06N 5/04; H04L 67/10; G06F 17/3053
USPC 706/46

(57) ABSTRACT

A system and method for recommendation delivery and tracking is provided. Users may use a smartphone enabled recommendation system to select products or media such as movies to recommend to other users. In one embodiment, the user uses the recommendation system to select a movie and select a recipient and the recommended movie is transmitted to the recipient. At the recipient, received recommendations are prioritized based on factors including the identity of the sender including the sender's overall recommendation approval rating and/or the specific-recipient approval rating. The recipient then evaluates and rates the recommendation and the rating is used in future recommendation prioritization.

### CROSS-REFERENCE TO RELATED APPLICATIONS

The present application claims the benefit of U.S. Provisional Application No. 61/859,970, filed Jul. 30, 2014, entitled “System and Method for Recommendation Delivery and Tracking”, which is hereby incorporated by reference in its entirety.

### BACKGROUND OF THE INVENTION

The present invention generally relates to electronic communication systems. More particularly, the present invention relates to systems and methods for communicating information with regard to products or services.

In everyday life, people are often interested in the recommendations of other people. For example, a first person may see a movie, realize that a friend may enjoy the move, and recommend the movie to a friend. However, the person receiving the recommendation may forget the recommendation or may not associate the same value to the recommendation as the person providing it. Additionally, it if difficult for a person receiving a recommendation to evaluate the accuracy of the person giving the recommendation except through trial and error.

More recently, some electronic recommendation systems have been developed, such as the Amazon recommendation system. These recommendation systems use previous purchases made by a first user to identify other users that have also made those previous purchases. The recommendation systems then look for products or media that have been purchased by the other users, but not yet purchased by the first user—at least according to the recommendation system's records.

Unfortunately, such electronic recommendation systems are frequently wrong for any of several reasons. First, the person receiving the recommendation may not have made all of their purchases through the same merchant. Second, the purchases made at the merchant may not represent the totality of the person's interests—or the person may have moved on to new interests over time. Third, the recommendation system lacks the personal insight that a personal relationship with the recommendation recipient may provide.

### BRIEF SUMMARY OF THE INVENTION

One or more of the embodiments of the present invention provide systems and methods for computerized recommendation delivery, tracking, and prioritization. Users of the system user their personal insight into other users to send recommendations of products or media that they believe may be enjoyed by the participants. Each user's recommendations are rated by the recipients and tracked by the system. The system then prioritizes recommendations from users that have higher ratings by recipients and displays statistics with regard to all users to allow users to make informed choices about their prospective activities.

### BRIEF DESCRIPTION OF THE DRAWINGS

FIG. 1 illustrates a flowchart of an embodiment of a process for sending a new recommendation as described herein.

FIG. 2 illustrates a flowchart of an embodiment of a process for receiving and rating a recommendation as described herein.

FIG. 3 illustrates a flow diagram of how a user may traverse one embodiment of a recommendation system and perform specific tasks as described herein.

FIG. 4 illustrates an exemplary login screen as described herein.

FIG. 5 illustrates an exemplary get started screen as described herein.

FIG. 6 illustrates an exemplary home screen as described herein.

FIG. 7 illustrates an exemplary main menu slideout as described herein.

FIG. 8 illustrates an exemplary comments screen as described herein.

FIG. 9 illustrates an exemplary new recommendation screen as described herein.

FIG. 10 illustrates an exemplary search movies screen as described herein.

FIG. 11 illustrates an exemplary compose new recommendation screen as described herein.

FIG. 12 illustrates an exemplary add recipient screen described herein.

FIG. 13 illustrates an exemplary recommendation detail page as described herein.

FIG. 14 illustrates an exemplary rate recommendation screen as described herein.

FIG. 15 illustrates an exemplary movie list as described herein.

FIG. 16 illustrates an exemplary user profile as described herein.

FIG. 17 illustrates an exemplary settings screen as described herein.

### DETAILED DESCRIPTION OF THE INVENTION

One or more embodiments of the present recommendation system provide a computerized recommendations platform that allows users to send, receive, request, rate and organize recommendations with their friends. Recommendations are sent to and received by users and archived into organized “to-do” lists based on the category of recommendation—movies to watch, music to listen to, books to read, tv shows to watch, products to buy, apps to download, services to hire, restaurants to eat at, or venues to visit. These recommendations are saved and tracked for users to access on their mobile device or on the web.

One or more embodiments of the present recommendation system are a communication tool for recommendations. One may almost think of one or more embodiments of the present recommendation system as a computerized recommendations exchange, storage, and tracking system, curated around sharing highly-targeted content with the people the user knows best. One aspect of the experience is centered around the action of sending recommendations to your close friends and family, getting feedback on those recommendations through a rating system, and collecting those recommendations into organized lists so that a user always knows what to watch, eat, listen to, read, or buy next.

Along with sending/composing recommendations, users may also request a recommendation from a friend.

In one embodiment, the present recommendation system may be a mobile-first experience. In one embodiment, the core interaction may take place within a mobile smartphone application such as an iphone application. In another embodiment, a web accessible system allows users to send, receive, archive and rate recommendations online as well. In a third embodiment, an Android application is used to provide the functionality described herein. Alternatively, an iPhone application may be used. In one embodiment, all of these recommendations and a history of a user's actions on our platform are saved to the cloud for that user to seamlessly access that information and mimic that experience on other devices by logging in to their recommendation system user account.

One or more embodiments of the present recommendation system allow users to send recommendations to non-users by utilizing SMS and email communication. By gaining access to a user's Contacts on their mobile device, we allow the user to send recommendations to their friends using email and text. This allows users to send content to friends who may not be recommendation system users yet, and is an efficient way to get those potential users to start using the recommendation system quickly and seamlessly.

One or more embodiments of the present recommendation system strive to connect people with products in a highly-targeted, meaningful, rewarding, and fun way that's never been done before.

1. Organized “To-Do” Lists of Recommendations Based on User Relationship

Each list is organized/prioritized/ranked in order of “best recommendation for you.” The order is determined by who is sending the user that recommendation and what the user's history of rating that person's previous recommendations is, as further described below. The more the user exchanges recommendations with an individual, the more the user builds a recommendation relationship with that friend. If the user tends to rate that friend's recommendations higher, the higher the priority and the higher on the user's list that person's recommendations will go. Prioritizing and organizing lists for users intends to help that user prioritize what they may watch, listen to, read, eat, or buy next.

Another way to affect the order of “to-do” items in a user's list is by the community's opinions on the recommendation through something called an “approval.” Approvals are the recommendation system's version that is similar to a Facebook “Like ” Whenever user A sees that User B sent User C a recommendation for a movie, if user A agrees with User B and thinks User C will enjoy that movie, User A may “Approve” that recommendation. Approvals on recommendations also affect the order in which those items fall on the user's “to-do” lists. The more approvals recommendations get, the more the community agrees with that recommendation, and the higher priority that item receives.

Additionally the user may order the recommendation lists by sorting them based on content score as described below based on the content score of recommended item for a particular user. Each item in the recommendation list would have a unique score for that content per user. Once calculated a sort based on content score would organize the to-do list based on the user's relationships, popularity of the item, and ideally the biases of the user.

2. Real-Time Notifications for Feedback on Recommendations

One or more embodiments of the present recommendation system use push notifications, email notifications, and SMS notifications for several things, including when a recipient of a recommendation rates that recommendation. The sender of the recommendation receives a notification immediately telling them what the recipient of their recommendation thought of it. Alternatively, the system may be configured in a private mode wherein the sender of the recommendation is either not notified when the receiver of the recommendation rates the recommendation or is only notified that the receiver of the recommendation has rated the recommendation, but not what the actual rating was.

Another example of a notification is when a friend approves a user's recommendation. If friend A approves friend B's recommendation to friend C, both friend B and C receive notifications that friend A approved of that recommendation. Again, the approval may be subject to a private mode wherein approvals are only shown to the receiver of the recommendation.

Furthermore, real-time notifications are sent to users when friends “Comment” on recommendations. One or more embodiments of the present recommendation system provide a place for friends to talk about content, products, and services. Whenever a new comment is added to the conversation surrounding a recommended item, anyone involved in that conversation receives a notification that a specific user added a comment to the thread. This reminds everyone to stay engaged and involved in the conversation about that recommended item.

3. Calculating Recommendation Score Based on Human to Human Interactions Rather than a Predictive Algorithm Based on what you have Previously Liked

One embodiment of the present recommendation system focuses on the human to human interaction to calculate good recommendations and the probability of a user enjoying that shared recommendation. Rather than relying on an algorithm that merely takes into account what the user happens to have previously liked or what the user's friends happen to have previously liked in an unknown context, one or more embodiments of the present recommendation system take into consideration the opinions of the people who know the user best to calculate the user's probability of liking that recommended item.

One approach to determine high probability linking of that recommendation is based on calculating the content score for a set recommendable items and displaying those to the user that meet a minimum content score. The content score used here is described below based on a user's friend network and a key feature in this metric is indeed the NetworkScoreFactor which is an aggregation of the user's friend relationships, combined biases as they relate to the user, and of course the friend's ratings.

Another approach is to calculate the Expected Rating as described below instead of the friend network content score as described above. In order to achieve this one would, for each recommendable item, calculate the expected rating value then sort by that expected rating value. The expected rating includes the friend network, their ratings and biases as well as other sources of information.

4. User Profiles and Recommendation Reputation

One or more embodiments of the present recommendation system are a social network of influencers and taste-makers. In one embodiment, users of the present recommendation system establish a profile on the network as soon as they sign up for an account. Users build their profiles the more they send recommendations, get those recommendations rated, and create successful recommendations because in one embodiment, the profile includes the user's recommendations sent, recommendations rated, and identification of successful recommendations. Successful recommendations are recommendations that are rated highly or added to the recipient's “Favorites” list. Each user's profile displays three statistics to show how good at recommending things that user is. Those three statistics displayed on the profile are: “Reccos Sent,” “Avg Return Rating,” and “Reccos Favorited.” “Reccos Sent” is the total number of recommendations that user has sent out. “Avg Return Rating” is the average number of stars a user rates that person's recommendations. “Reccos Favorited” is the number of recommendations that user sent out that were added to the recipient's “favorites” list.

Users are scored in each category for how influential they are in that particular category. If a user is extremely successful in recommending movies, but the restaurants he recommends get rated poorly, that will be reflected in his public profile. Users may view their friends' profiles to see where their friends' influence is strongest. One or more embodiments of the present recommendation system may also highlight the top movie recommenders, the top Restaurant recommenders, etc. and the top recommenders in the other recommendation categories mentioned herein, among the user's friends and/or contacts. By discovering who the user's most influential friends are in certain categories, users will be more prone to requesting recommendations in those categories from those reputable users.

5. Insightful Consumer Data

One embodiment of the present recommendation system collects insightful consumer data that will be valuable to marketers, advertisers, and brands. One or more embodiments of the present recommendation system aims to collect usage data on the demographics responsible for pushing products and sharing brands effectively. One example of this embodiment would be the following: Warby Parker eye glasses company may log onto a recommendation system enterprise web portal and be able to access visual demographic data on consumers who are sharing their product and brand the most. Warby Parker may use this insightful data to interpret and identify who their “brand advocates” are and tailor their marketing efforts to efficiently target and message to this unique segment of customers. If Warby Parker may effectively target and message their brand advocates, those brand advocates (recommendation system users sharing Warby Parker products with their friends) will handle the rest of their marketing efforts by spreading organic suggestions and recommendations with their friends who aren't yet aware of the great glasses Warby Parker has to offer. Rather than trying to please the masses, Warby Parker now has an avenue to access and build their product around a much smaller and targeted segment of the market—their most influential customers on the recommendation system. Warby Parker may also use this as an opportunity to reach out and contact their brand advocates. They may facilitate conversations with these recommendation system users to establish insights on how to better improve and innovate their product. Warby Parker may also set up a rewards system with these users and incentivize them to continue advocating their product.

One or more embodiments of the present recommendation system track “Word of Mouth Marketing” data. One or more embodiments of the present recommendation system knows who the first person in a network of friends is to send a specific recommendation, who it went to next, then next, then next, etc. The recommendation system calls this the “6 Degrees Algorithm.” The 6 Degrees Algorithm may quantify the total reach (number of users who receive that recommendation) that a single recommendation creates. If two users recommend the same product to a single receiver, one or more embodiments of the present recommendation system will only count the person who sent it first. If a user tries to send something to a friend who already has that item in their list from another user, recommendation system will notify the sender they were beaten to the punch by another user. One or more embodiments of the present recommendation system will then ask the sender if they'd like to “Approve” the original sender's recommendation.

We aim to utilize this technology to potentially reward the most influential users (the users who share popular items first) on recommendation system's network. One example of rewarding one of these users would be to give them a certain cut or percentage of the revenue generated from an affiliate link. In this embodiment, if a user successfully sends a recommendation for a product, and consequently a lot of users buy that product from that recommendation, recommendation system will reward the sender of that recommendation with cash from the revenue generated with that recommendation.

6. Rewards System Based on Recommendations

In one embodiment, when a user recommends a product to a friend and that friend purchases that product, the recommendation system will reward the sender of that recommendation a profit cut from the revenue generated through the affiliate link.

Users of the recommendation system may also be incentivized by the products/brands/services they're recommending with coupons, deals, and promotions. For example, if Warner Bros wants to include half-off ticket purchases to all of their new movies being recommended, Warner Bros will have the power to customize what a user sees on their recommendation detail screens for all Warner Bros movies in theatres. One example of this embodiment is through an enterprise recommendation system Web Portal designed specifically for businesses, brands, products, and services to create an enterprise account and establish/customize their own deals, coupons, rewards, or access customer data. These businesses that generate enterprise accounts on the recommendation system Enterprise Portal pay a subscription fee to the recommendation system in order to access the customer data and customize their incentive programs for their customers.

In one embodiment, the app houses/stores all of the user's perks (deals, coupons, benefits, prizes, etc.) that he or she has received by using the recommendation system app. The user may access these perks at anytime and redeem them on their mobile device. One example of this embodiment would be if a user received a half off discount on movie tickets with Warner Bros Studio for successfully sending 10 WB movies, they would get a notification from the recommendation system notifying them they have 1 new Coupon awaiting redemption in their “Deals” folder of the app. The user navigates to their “Deals” section, and inside they may see the new deal waiting to be redeemed. When the user is ready to redeem this coupon at the theatre, the user may pull out their mobile device, open the recommendation system app, navigate to the “Deals” section, open the Warner Bros half off coupon, and display this coupon to the theatre. In some cases, this coupon/deal/perk may involve a bar code which would be scanned at the venue where redeemed.

The monetary benefit to a user is balanced by the reputation they're establishing in the recommendation system community. Users will not want to spam their friends too much, because bad ratings mean a bad recommendation system reputation. It also means that their recommendations will go lower on the lists of their friends if they are rated lower by their friends, and will most likely be ignored. In one embodiment, we feature the top recommenders each week, highlighting the power users who are using the product the way it was intended—sharing awesome things with the people they care about. These featured lists will highlight not only the users who are sending the most successful recommendations, but also the users who are most influential—the users who share the highly-rated and most-recommended items the earliest, and the users with recommendations that are shared by others the most.

### Additional Embodiments

1. Machine Generated—‘Suggested People’ to Send the Current Recommendation to

When a user rates/favorites a recommended product we may show them a suggested list of recommendation system users who would potentially enjoy that product. The reasoning behind this would be to persuade the user to forward that recommendation onto a friend and continue to push that product along the line of users. We do so by calculating who would best potentially enjoy that product by checking the current user's contacts and matching those contacts' preferences and tastes with the current rated recommendation. An example of this embodiment would be if a friend recommended me a horror film. If I watched this recommended honor film and rated it highly (at least 4 stars), the recommendation system will suggest users that I've previously successfully recommended horror movies to before.

Another approach to building a list of suggested people is by calculating the content score (as described below) of that item for each of that user's contacts. Once the recommendation system has the content score for each contact the system may then sort the users contacts by the content score, contacts with the highest content score may have a greater likely hood of enjoying the recommendation.

It is also possible to sort the contacts by the expected rating (as described below) in a similar manner to how described above. If the contacts are sorted by the expected rating, contacts with the higher expected ratings may also have a greater likely hood of enjoying the recommendation.

2. Notifications of the User's Favorite Products being Rated by Contacts.

A contact of the user just rated a product and it happens to be a favorite of the user's. Even though the first user didn't send the recommendation to that user, we may still notify the first user. This would promote conversation between the two users around the common taste of the “favorited” item.

Whenever a first user rates an item another user may scan the first user's contacts to see if that item is in any of that other user's contacts set of favorite items. In the event that item is in a set of favorites that other user or contact may be notified of such rating.

3. Highly Relevant Advertisements Based on Highly Rated Products from Friends.

A product has reached endorsements from several of the user's contacts. That product may potentially serve as a highly effective advertisement to the user. For example a message may be displayed to the user that reads: “These friends {list} experienced {product} and their average rating is {rating}. Click here to learn more.”

Given a set of ad inventory with each having these potential requirements—A minimum quantity of friend endorsements and/or minimum aggregate rating

We may calculate for any user in the system which of the ad inventory items criteria is met and therefore is relevant to that user. If any such item's criteria are met the recommendation system may deliver the advertisement.

4. Browse a List of Rated Products By Friends

Given a list of a user's contacts the recommendation system may show up-to-date and current analytics (average ratings and ratings distributions) for products the user's contacts have liked or disliked. This would be helpful for users when they are trying to discover a product in a category they might enjoy. Based on the user's contacts' ratings of [products], the recommendation system may suggest checking them out.

Additionally from such a list some actions are performable with a single click including: a) Ask your contacts if they would recommend that product to you, and b) or you may Add it to your own list.

5. Group Event Planning

A user creates an event page and invites people to it. This event page then helps users coordinate when, where and what to do

This page shows a calendar and allows users to input their availability in time, and their general location. The recommendation system then shows options of venues and times to the users, this allows for the participating users to vote on or veto these options.

If the users have an event in mind (for example a particular movie) the application suggests to them options of venues that try to best meet the criteria set by the users. In the example of a movie, the application may list theaters within a user-selectable radius of an identified location, such as the GPS location of the user setting up the event page. The movies may also be sortable by the user with regard to time so that users may select movies that are either closer or more preferable in time—or may balance the two factors.

If the users have a location in mind, but not a particular event, the application suggests to them events and when they are at that location. The events have arrangements based on the combined users preferences and potential “To-do” lists.

To calculate the combined preferences of a group of users we take the set of possible events and calculate the group content score for each event (as discussed below). With the group content scores calculated we may present the list of items sorted based on group content scores. This assists in helping the group prioritize events based on their collective tastes.

Additionally, when picking events in one embodiment there may be group discounts to these events. Such discounts that meet the advertisement criteria would be reflected or preferentially bubbled to the top of the options. These advertisements may be selected depending on the known preferences of the groups.

We may also suggest users to invite to events based on the history of the products/services they've rated highly or lowly. This may be applicable to Facebook's event creation process. In the example of organizing a watch party for the hit HBO original series, Game of Thrones, the recommendation system may suggest attendees for the event based on who of your contacts have also rated that show.

6. “Online Remote”/Private Events.

Watch a movie or listen to music online (or together) with friends. Based on recommendations and ratings among friends and combined “To-Do” lists the recommendation system may: a) Suggest someone to enjoy the content a user has in mind, based on similar tastes, and/or b) Suggest content to enjoy with people the user invited. The recommendation system may suggest content they both might enjoy based on their combined profiles and rating history.

To implement scenario a) the system may scan the contacts of the user looking to invite someone and calculate the content score (as described below) for each contact. Then organize them by each contacts content score. Additionally, instead of calculating the content score the system may calculate each contact's expected rating (as described below) and organize them by the expected rating. Either of these methods may help alert or bring contacts who might enjoy the content with the user.

To implement scenario b) the system may calculate the combined preferences of a group of users by taking the set of possible events and calculate the group content score for each event (as described below). With the group content scores calculated the system may present the list of items sorted based on group content scores. This may assist in helping the group prioritizing content based on their collective tastes.

7. Clients Generating Deals, Coupons, Perks to Customers Based on Successful Recommendations

One or more embodiments of the present recommendation system aim to reward users who successfully share content with their friends. This application may also be used by others looking to set up a rewards system for their customers. A local restaurant may provide a coupon to any customer who recommends their restaurant on the recommendation system to 5 different friends. Warner Bros may give free movie tickets away if you get a friend to rate one of their movies 5 stars and add it to their favorites list.

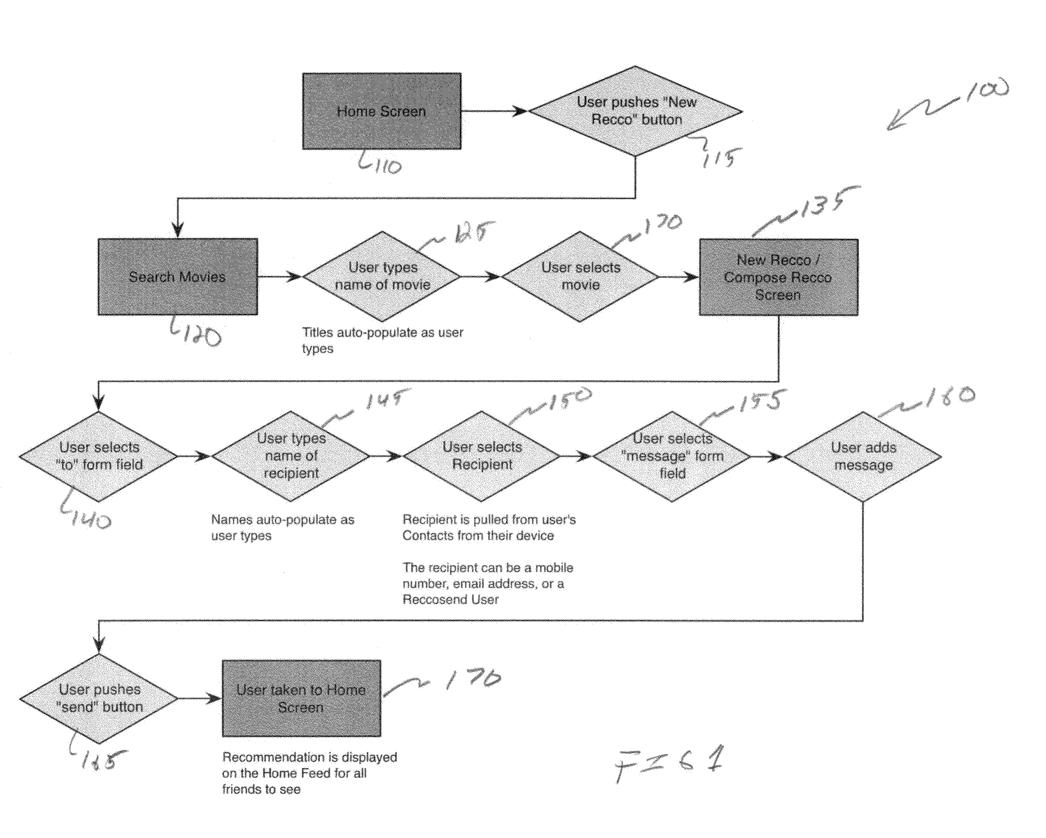

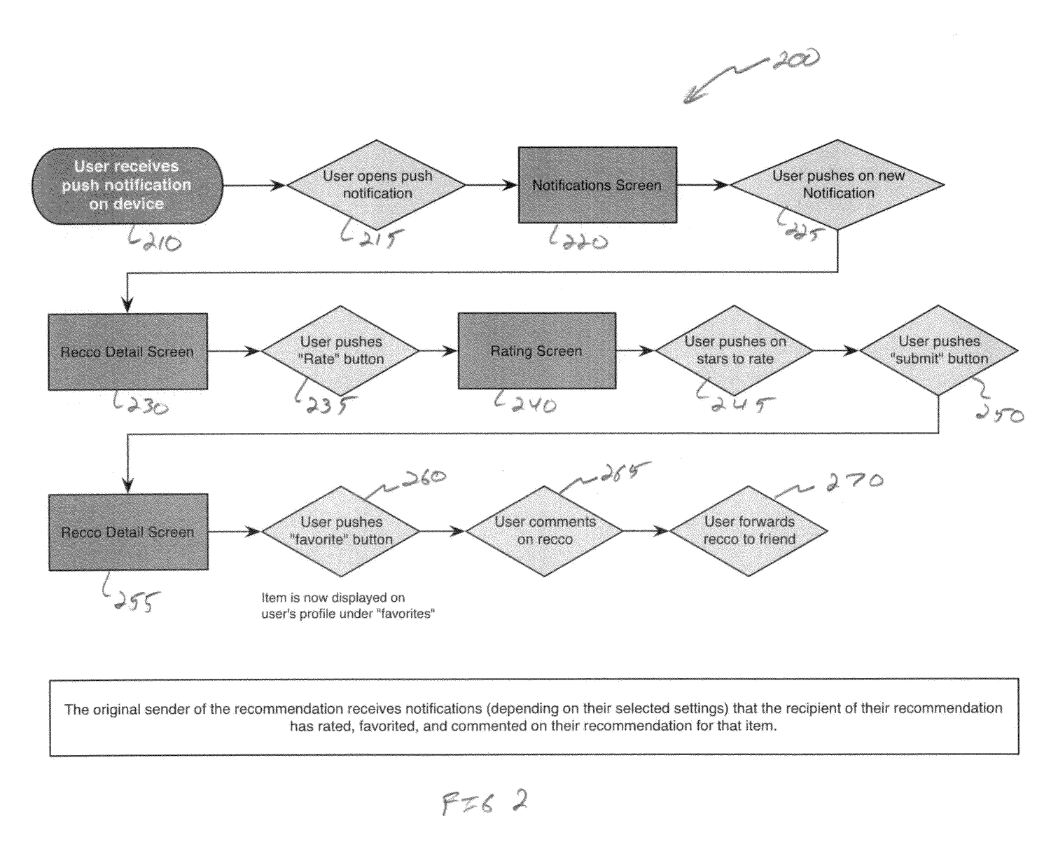

FIG. 1 illustrates a flowchart 100 of an embodiment of a process for sending a new recommendation as described herein. First, at step 110, the recommendation system application is initiated and the recommendation screen is displayed. Then, at step 115, the user activated the “New Recco” button to initiate the new recommendation process and indicates that they would like to recommend a movie. The flowchart proceeds to step 120 where the user may search for their desired movie. At step 125, the user starts typing in the name of the movie and titles matching the user's typing are automatically displayed as the user types. Then, at step 130, the user selects a desired movie to recommend from the listing of one or more movies matching the user's typing. Once the movie has been selected, the flowchart proceeds to step 135 where a new recommendation screen is displayed and is populated with the information for the selected movie.

Next, at step 140, the user selects the “to” field in the new recommendation screen and types in the name of an intended recipient of the recommendation. The recommendation system automatically reviewed the contacts available on the user's smartphone and displays a list of contacts matching the user's typing. Next, at step 150, the user selects a desired recipient from the listing of contacts. The recipient information is retrieved from the user's contacts on their device or smartphone. The recipient may include a mobile number, an e-mail address, or some other user of the recommendation system.

Next, at step 155, the user selects the “message” field of the new recommendation screen, if desired. At step 160, the user adds a message to the recommendation if desired. The flowchart then proceeds to step 165 where the user activates the “send” button to transmit the recommendation to the indicated recipient. Finally, at step 170, the recommendation system returns to displaying the home screen. Additionally, the recommendation that has just been sent is displayed on a home feed where it is viewable by other users of the recommendation system that have been indicated as friends.

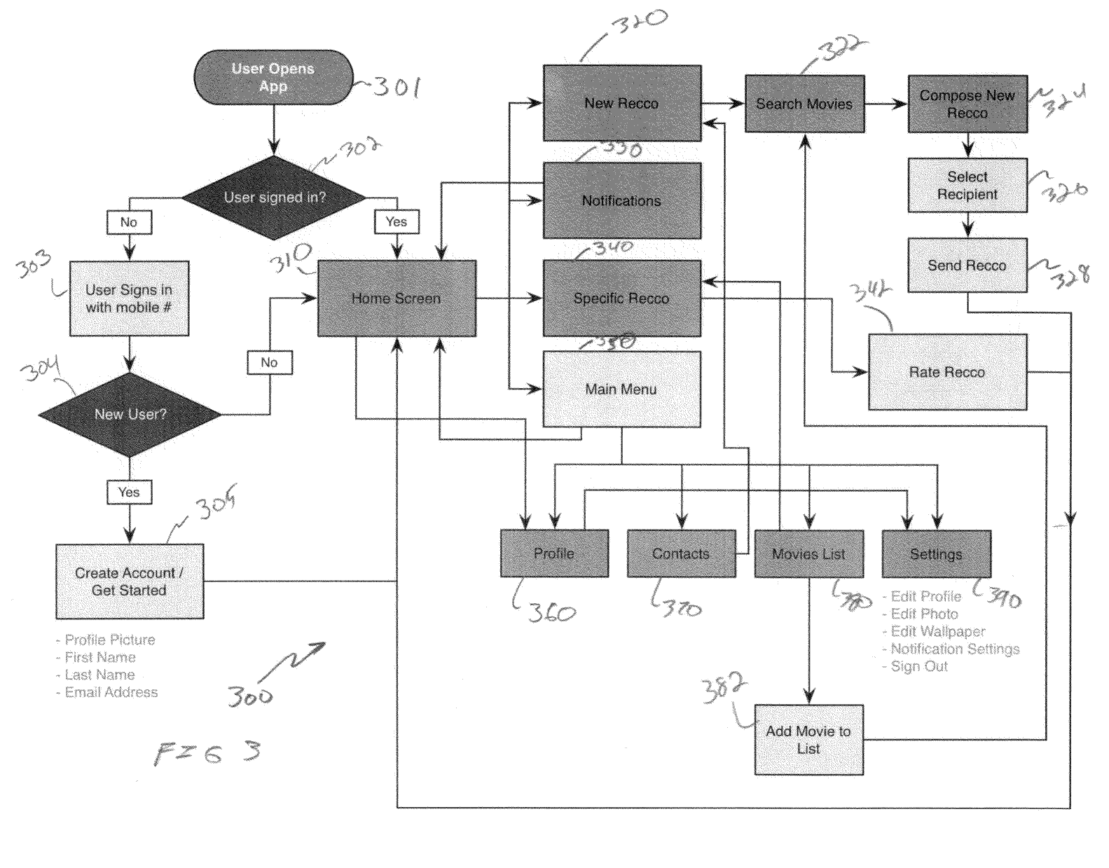

FIG. 2 illustrates a flowchart of an embodiment of a process for receiving and rating a recommendation as described herein. First, at step 210, a user received a push notification on a user device. In one example, the push notification may be an e-mail or SMS text and the user device may be a smartphone or computer. Next, at step 215, the user opens the push notification and the recommendation system is directs the user to the recommendation system's notification screen, which is displayed on the user's device at step 220. Next, at step 225, the user selects an indicator displayed on the screen, wherein the indicator represents the new notification that has been pushed to the user.

At step 230, the recommendation system then displays a recommendation detail screen representing the recommendation that was pushed to the user. The user then reviewed the recommendation detail screen. At step 235, the user selects a “Rate” button displayed on the recommendation detail screen. The process then proceeds to step 240 wherein the rating screen is displayed.

At the rating screen, the user then selects a rating for the recommended product or media. The rating may be a number of stars from one to five representing the rating that the user is giving to the product or media. Next, at step 250, the selects the “submit” button to submit their rating. The process then proceeds to step 255 and the recommendation detail screen is again displayed.

Next, at step 260, if the user desires to indicate that the product or media displayed in the recommendation detail screen is a favorite of the user, the user then selects the “favorite” button. The product or media is then displayed on the user's profile in a section entitled “favorites”. The process then proceeds to step 265, wherein the user may optionally comment on the recommendation by typing in a comment through the recommendation detail screen. Next, at step 270, the user may optionally forward the recommendation to a friend or contact.

Additionally, the original sender of the recommendation may receive one or more notifications (depending on their selected settings) that the user receiving the recommendation has rated, favorited, and/or commented on the recommendation.

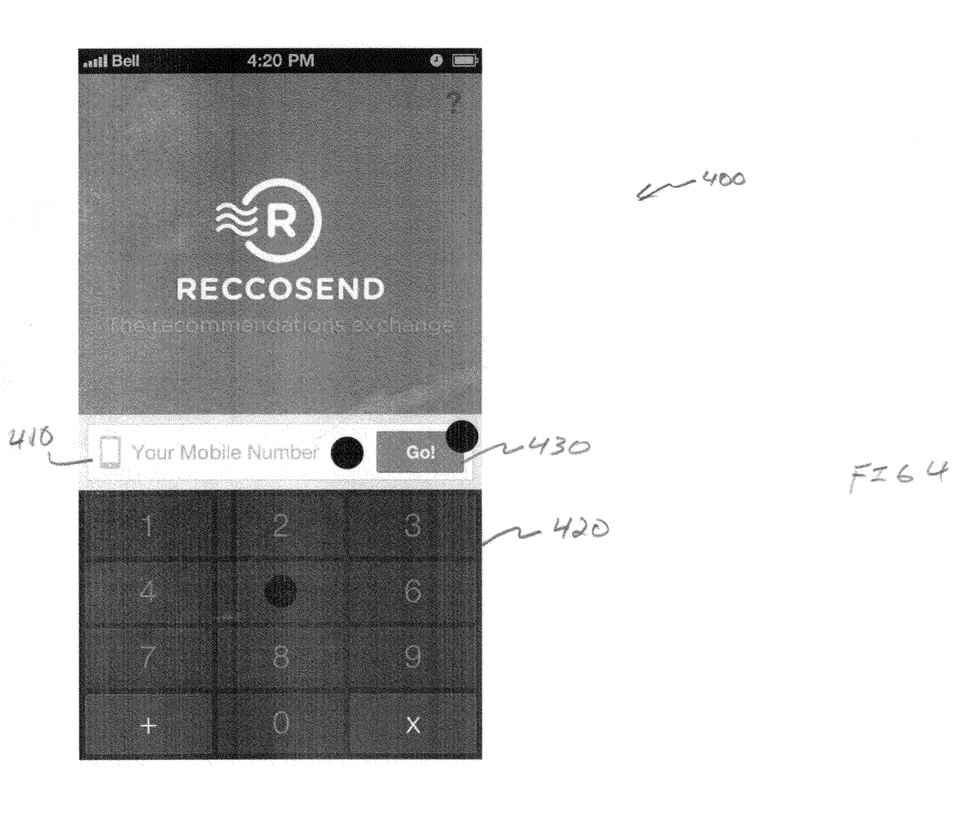

FIG. 3 illustrates a flow diagram 300 of how a user may traverse one embodiment of a recommendation system and perform specific tasks as described herein. First, at step 301, the user may open, initiate, or activate the recommendation system application, for example using a smartphone. At step 302, the system checks whether the user is signed in to the recommendation application. If the user is signed in, then the flowchart proceeds to step 310 and the system displays the home screen on the user's device.

If the user is not signed in, then the flowchart proceeds to step 303 and the user may proceed to sign in, for example using their mobile number and/or a password. Once the user enters their credentials, they are evaluated at step 304. If the user does not have an account on the system, then the flowchart proceeds to step 305 and the user may create an account on the system, for example by uploading a profile picture, choosing account information such as a login and/or password, and entering personal information such as first name, last name, and e-mail address. The flowchart then proceeds to step 310 and the home screen is displayed.

Alternatively, if the user is not a new user, then once the user's credentials are evaluated at step 304, the flowchart proceeds directly to step 310 and the home screen is displayed.

At the home screen in step 310, the user is presented with the options of directing the system to display the new recommendation screen 320, the notifications screen 330, a specific recommendation screen 340, the main menu 350, and the user's profile 360.

When the user selects the new recommendation screen 320, the user may search movies at step 322, compose a new recommendation at step 324, select a recipient at step 326, and then send the recommendation to the recipient at step 328. The flowchart then returns to the home screen 310.

When the user selects the notifications screen 330, any notifications that have been stored for the user are then displayed. The flowchart then returns to the home screen 310.

When the user selects the specific recommendations screen 340, one or more specific recommendations may be displayed for the user. The recommendations may be rated by the user at step 342. The flowchart then returns to the home screen 310.

When the user selects the main menu 350, the user is provided with the option of then selecting the user's profile 360, the user's contacts 370, the user's movie list 3800, and the user's settings 390. Additionally, each of these screens may be switched to directly from the user from any of the other screens.

Also, from the user's contacts 370, the user may initiate a new recommendation by selecting a contact. The flowchart then proceeds to step 320 and a new recommendation may be made.

Additionally, from the user's movie list 380, the user may select a movie. The flowchart then proceeds to step 340 and the specific recommendation for the movie is displayed. Additionally, although the user's movie list 380 is shown, other lists of products or media are also available including a music list and a restaurant list. Additionally, from the user's movie list 380, the user may select a movie and the proceed to step 382 to add the movie to a list. The flowchart then proceeds to step 322 and movie may be searched.

Once the user is done with any of the user's profile 360, the user's contacts 370, the user's movie list 3800, and the user's settings 390, the flowchart may return to the main menu 350 and/or the home screen 310.

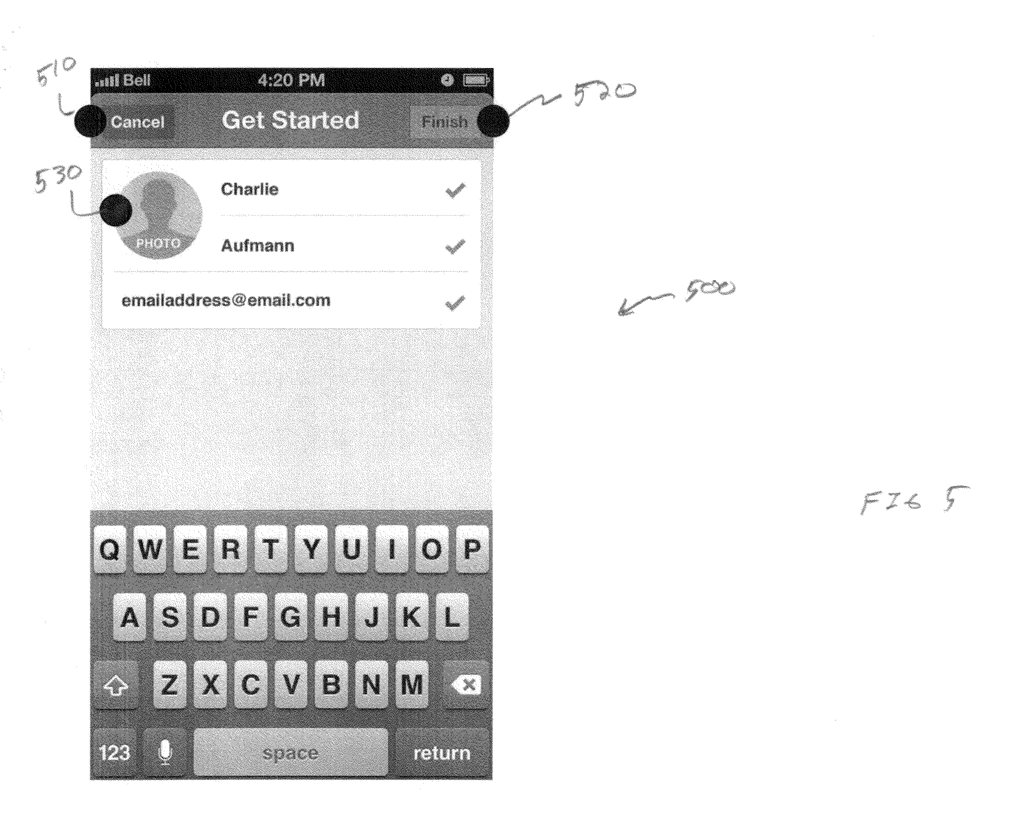

FIG. 4 illustrates an exemplary login screen 400 as described herein. The login screen 400 includes a text field 410, a keypad 420, and a go button 430. The text field 410 allows a user to enter their mobile number or other identifier or credential to gain access to the recommendation system so that the user may sign on or create their account. The keypad 420 allows the user to enter their mobile number directly. The go button 430 is selected by the user when they have completed entering their mobile number.

When accessing the recommendation system, the login screen 400 is the first screen presented to the user if they are not already signed in to the recommendation system.

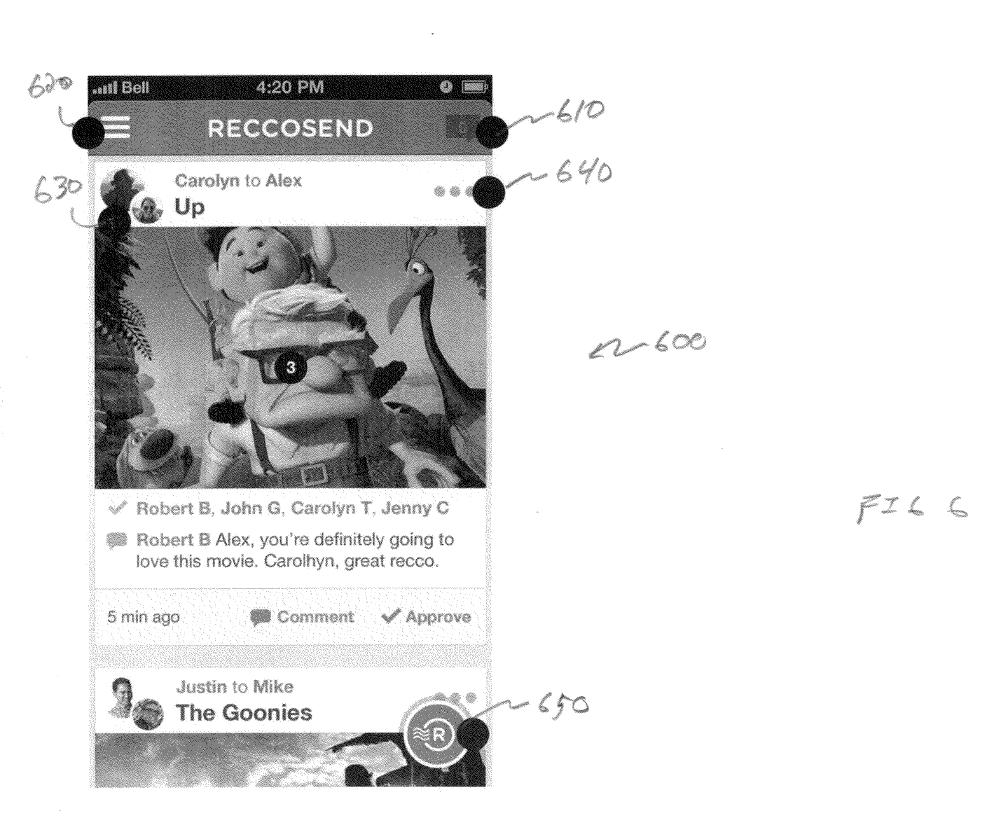

FIG. 5 illustrates an exemplary get started screen 500 as described herein. The get started screen 500 includes a cancel button 510, a finish button 520, and an add photo button 530. In operation, the user may select the cancel button 510 to cancel setting up their account. The user may use the finish button once they have completed entering their credentials such as first and last name and e-mail address. Additionally, the user may select the add photo button 530 to add a photo to their profile. For example, the user may upload their own photo or take a photo with their phone.

The get started screen 500 may be used by new users to create their account with the recommendation system. In one embodiment, in order to generate an account with the recommendation system, a new user may enter their mobile number into the login screen, then enter their First Name, Last Name, and email address.

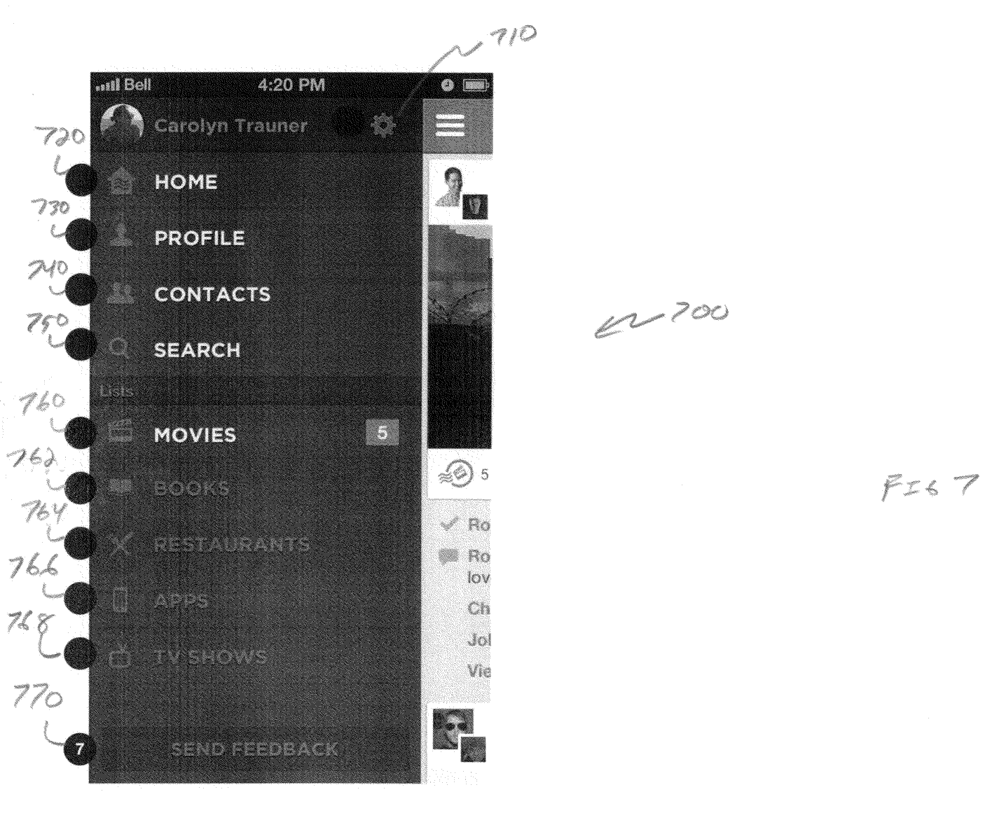

FIG. 6 illustrates an exemplary home screen 600 as described herein. The home screen 600 may also be known as the user's feed. The home screen 600 serves as a running feed of all of the recommendations being sent between all of the user's friends on the recommendation system. Users can browse this screen to see what items, products, and/or media are being recommended between their friends, comment on the conversation, add those items to their own lists, and approve those recommendations.

The home screen 600 includes a notification button 610, a menu button 620, a recommendation 630, an action button 640, and a new recommendation button. The notifications button 610 indicates how many new and unread notifications the user has. Selecting the notifications button 610 causes the recommendation system to display the notifications screen as discussed below.

Selecting the menu button 620 causes the recommendation system to display the main menu as discussed below.

The recommendation 630 represents an embodiment of a recommendation that may be sent to the user. The recommendation 630 includes a display of who is sending the recommendation to whom, such as “Carolyn to Alex”, the the artwork/image for that item being recommended, such as the movie “Up”, a timestamp for when the recommendation was sent, such as “5 min ago”, any comments on the recommendation, such as “You're going to love this movie”, and any approvals of that recommendation, such as “Robert B, John G, Carolyn T, Jenny C”.

Additionally, the recommendation 630 may display the photos of the sender and the receiver as shown. The larger and/or upper photo may be the sender and the smaller and/or lower photo may be the receiver.

When the action button 640 is selected, an action sheet is displayed by the recommendation system that presents the user with action items for that recommendation. The action sheet preferably displays the options to Add item to list, Send item to friend, or cancel.

When the new recommendation button 650 is selected, the recommendation system creates a new recommendation to be send to a friend or contact as further described herein.

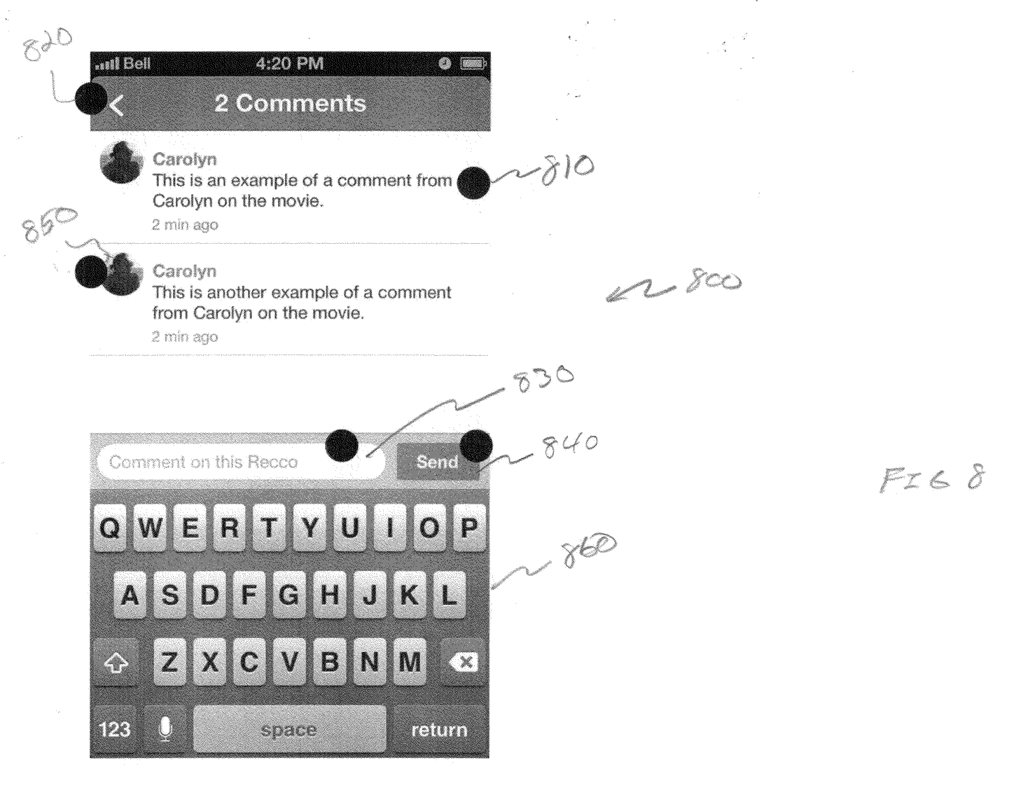

FIG. 7 illustrates an exemplary main menu slideout screen 700 as described herein. The main menu slideout screen 700 may be accessed by sliding laterally across the face of the home screen 600. The main menu slideout screen 700 includes a settings button 710, a home button 720, a profile button 730, a contacts button 740, a search button 750, several lists buttons 760-768, and a send feedback button 770.

As described herein, when the settings button 710 is selected, the recommendation system displays the user's personal settings. When the home button 720 is selected, the recommendation system displays the home screen. When the profile button 730 is selected, the recommendation system displays the user's profile. When the contacts button 740 is selected, the recommendation system displays the user's contacts. Preferably all contacts in the user's phone including users of the recommendation system and non-users of the recommendation system are displayed. For example, the user may wish to send a recommendation to a non-user of the recommendation system in order to induce them to become a user of the recommendation system. When the search button 750 is selected, the recommendation system displays the search screen as described herein.

The lists buttons 760-768 may include a movies list 760, a books list 762, a restaurants list 764, an apps list 766, and a TV shows list 768. When a specific list button is selected by a user, the recommendation system displays the selected list.

When the send feedback button 770 is selected, the recommendation system generates an e-mail that will be send to the designers or administrators of the recommendation system so that users can provide feedback with regard to the recommendation system.

In one embodiment, the main menu slideout screen 700 may be the main navigation tool to access the home screen, user profile, user contacts, search, and Lists.

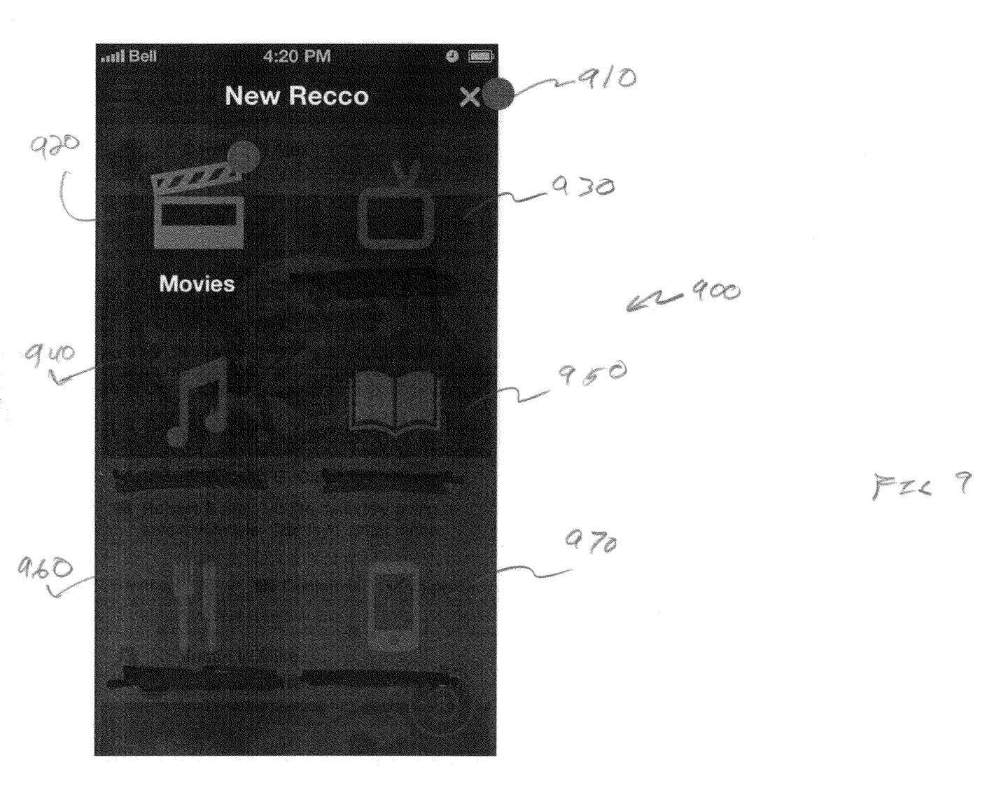

FIG. 8 illustrates an exemplary comments screen 800 as described herein. The comments screen 800 includes a comment 810, a back button 820, an add comment button 830, a send button 840, a commenter's photo 850, and a keypad 860.

The comment 810 is an example of a comment a user created about a recommendation displayed above. When the back button 820 is selected, the recommendation system displays the previously displayed screen. When the add comment button 830 is selected, a user may enter a comment using the keypad 860. When the send button 840 is selected, the comment entered by the user is sent and submitted to the recommendation system for attachment to and/or display with the recommendation. Additionally, a photo of the user who submitted the comment may be displayed.

Comments can be added by users as a way of conversing about recommendations. The Comments Screen may be accessed from at least two locations: the home screen and the recommendation detail screen.

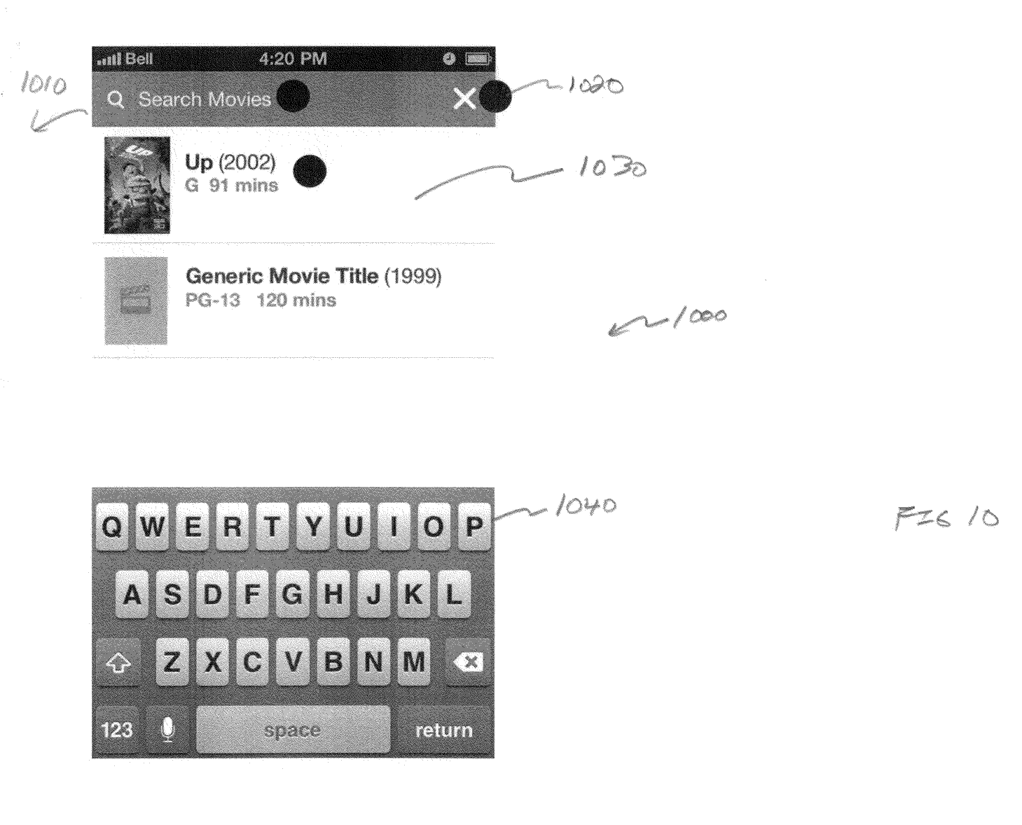

FIG. 9 illustrates an exemplary new recommendation screen 900 as described herein. The recommendation screen 900 includes a cancel button 910, a movie recommendation button 920, a TV recommendation button 930, a music recommendation button 940, a book recommendation button 950, a restaurant recommendation button 960, and an app recommendation button 970.

When the cancel button 920 is selected, the user may cancel out of the recommendation process and the recommendation system may then display the home screen.

When the user selects one of the recommendation buttons 920-970, a new recommendation screen for that product or media type is displayed by the recommendation system. The new recommendation screen then allows the user to select a specific movie, for example, or a specific contact, and start the recommendation creation process. Additionally, the user may scroll down vertically to access other categories of recommendations to select.

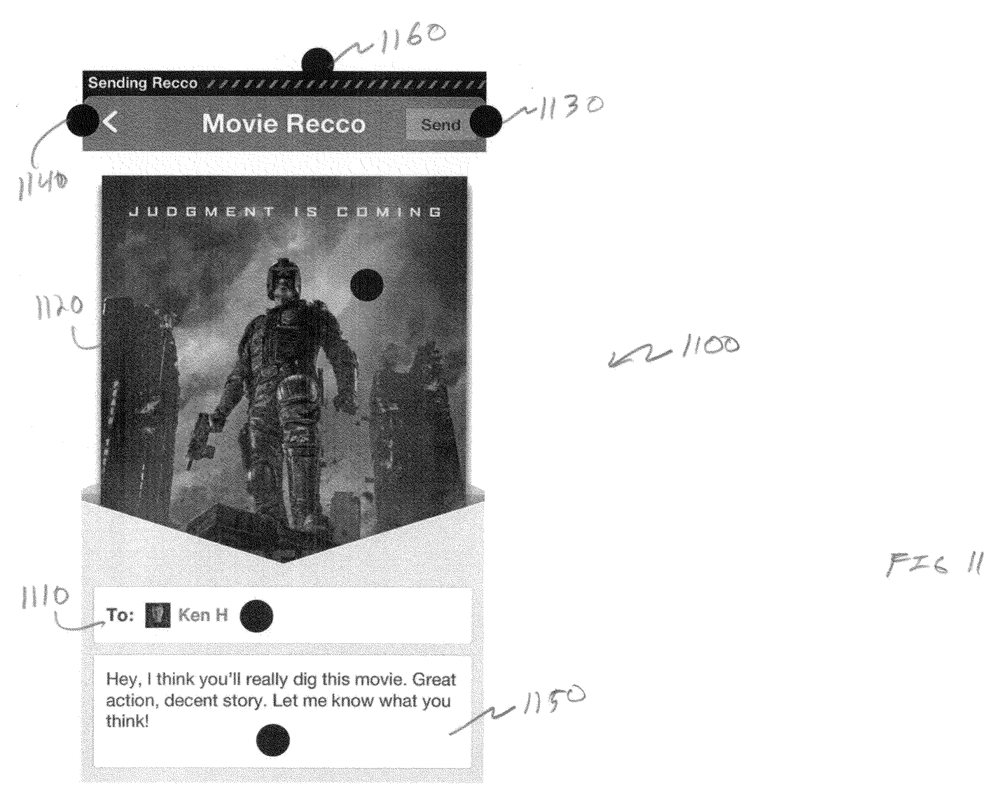

FIG. 10 illustrates an exemplary search movies screen 1000 as described herein. The search movie screen 1000 includes a search field 1010, a cancel button 1020, a movie search result 1030, and a keypad 1040. When the cancel button 1010 is selected, the recommendation system displays the previous screen.

In operation, the search field 1010 may be selected and the keypad 1040 may be used to enter the title of a movie to be searched. After selecting the type of recommendation a user wants to send, the recommendation system displays the search movies screen where the user may search for the exact movie that they would like to recommend to someone. Search results such as movie search result 1030 may then be displayed. Preferably, search results automatically appear in the results table view as the user types the movie they're searching for into the recommendation system. Pushing on one of these movies in the list selects the movie and brings the user to the “compose recommendation” screen.

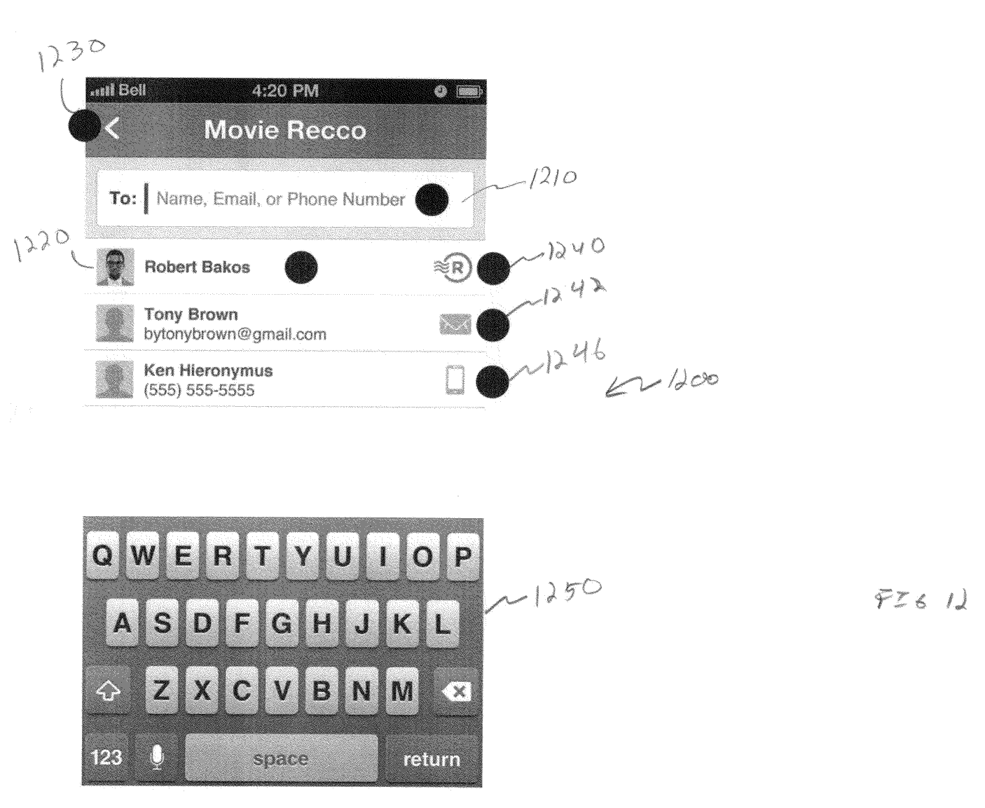

FIG. 11 illustrates an exemplary compose new recommendation screen 1100 as described herein. After selecting the type of recommendation a user wants to send, they are brought to this screen where for example, they search for the exact movie they would like to recommend to someone. FIG. 11 includes a recipient input field 1110, a recommendation artwork 1120, a send button 1130, a back button 1140, a comment field 1150, and a progress bar 1160.

The recipient input field 1110 allows a user to enter the name of the recipient and displays the name of the recipient of the recommendation. The photo displayed in the “To” field is the photo of the person the user is sending the recommendation to. Additionally, tapping this input field brings up the “Add Recipient” screen (outlined on following screenshot).

The recommendation artwork 1120 is artwork associated with the media or product being recommended.

When the send button 1130 is selected, the recommendation is sent to the person or persons listed in the recipient input field 1110. This button is deactive until the user enters at least one name for the person they're trying to send the recommendation to

When the back button 1140 is selected, the recommendation system displays the previous screen.

The comment field 1150 is optional. The user sending/creating this recommendation has the option to add their own personal message to the recommendation.

Once the send button is pushed, the progress bar 1160 shows until the recommendation has successfully sent.

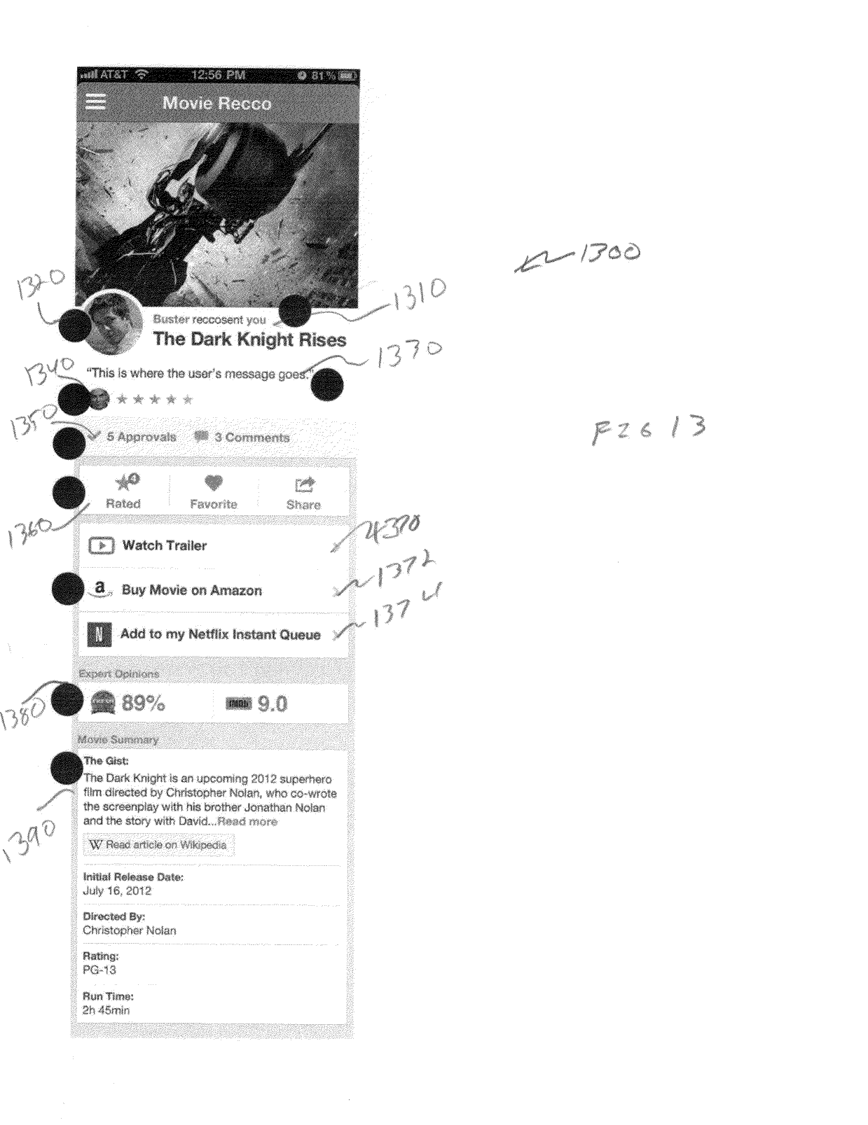

FIG. 12 illustrates an exemplary add recipient screen 1200 described herein. The add recipient screen 1200 is the interface that is displayed after a user taps the input field to add a recipient to their recommendation

The add recipient screen 1200 includes a recipient input field 1210, search results 1220, a back button 1230, contact icons 1240-1244 representing the type of contact that is displayed in the search results, and a keypad 1250. When the back button 1230 is selected, the recommendation system displays the previous screen.

In operation, the user may select the recipient input field 1210 and then enter a recipient name using the keypad 1250. As the user enters the recipient name, search results are shown in the search results 1220. This list is preferably pre-populated with the previous recipients from the user's last few recommendations sent, but the user has the option to select any contact from their phone's contacts by typing the name of that contact in this input field 1210. The user may then select any displayed contact by pressing on the contact.

Additionally, the contact icons 1240-1244 may indicate when the contact is a user of the recommendation system 1240, an e-mail address 1242, or a mobile phone 1244.

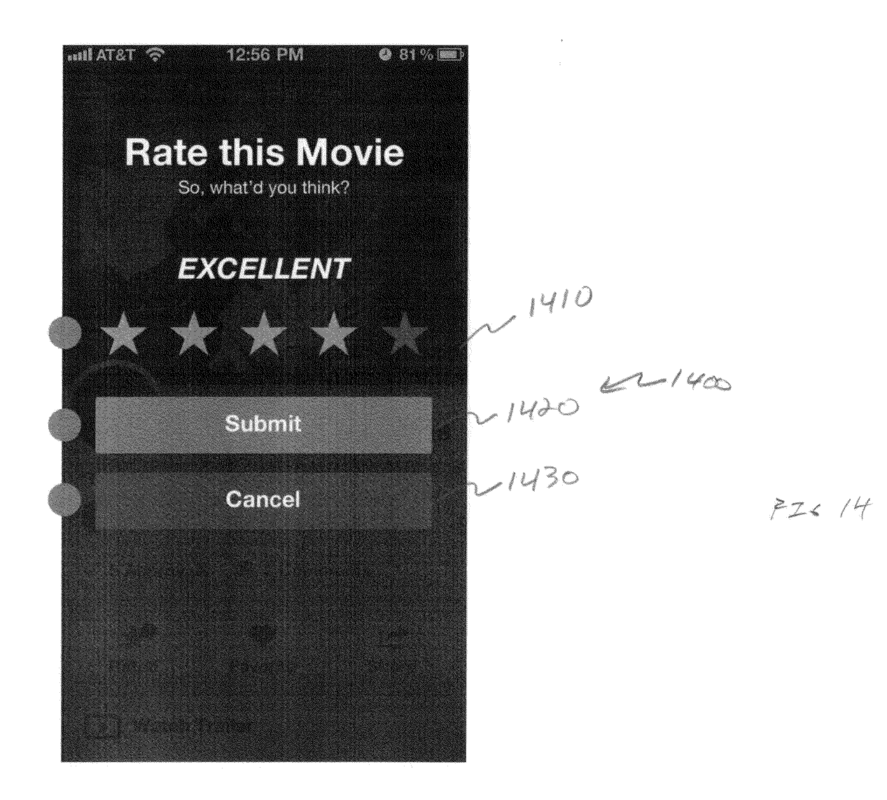

FIG. 13 illustrates an exemplary recommendation detail page 1300 as described herein. This is the screen a user would see if they clicked into a specific recommendation. This screen provides information for the item that was recommended. It also provides action items for the user to buy the product, rate it, favorite it, share it, etc.

The recommendation detail page 1300 includes a recommendation title 1310, a sender's profile photo 1320, a message 1330, a recipient rating 1340, approvals and comments 1350, an action bar 1360, a watch trailer button 1370, a buy media button 1372, an add to delivery queue button 1374, expert ratings 1380, and a movie summary 1390.

The recommendation title 1310 displays the name and title of the product or media being recommended as well as the person who sent it and the recipient of the recommendation

The sender's profile photo 1320 is the profile photo of the sender. The message 1330 is an optional message that the sender may have added with the recommendation.

The recipient rating 1340 displays the rating entered by the recipient once the recipient has rated the recommendation.

The approvals and comments 1350 are any approvals or comments that have been made on the recommendation. The user can push on these to display the details of approvals and comments for that recommendation

The action bar 1360 has three buttons for a user to push: 1) Rate, 2) Favorite, and 3) Share. The user can rate the recommendation, favorite the recommendation, or share it. Pushing on Rate brings up the screen for the user to rate the recommendation. Favoriting the recommendation adds that item to their favorites list on their profile. Sharing allows the user to send the recommendation to another friend or add the item to their own list.

The watch trailer button 1370, buy media button 1372, add to delivery queue button 1374, allow the user to respectively be displayed a trailer associated with the movie, redirect the user to a commerce portal such as Amazon for purchase of the media, and add the movie to a delivery queue, such as the Netflix Instant Queue.

The expert ratings 1380 may display ratings of the movie by experts such as by Rotten Tomatoes and IMDB. The movie summary 1390 displays information with regard to the movie from Wikipedia along with the link to access the full Wikipedia page.

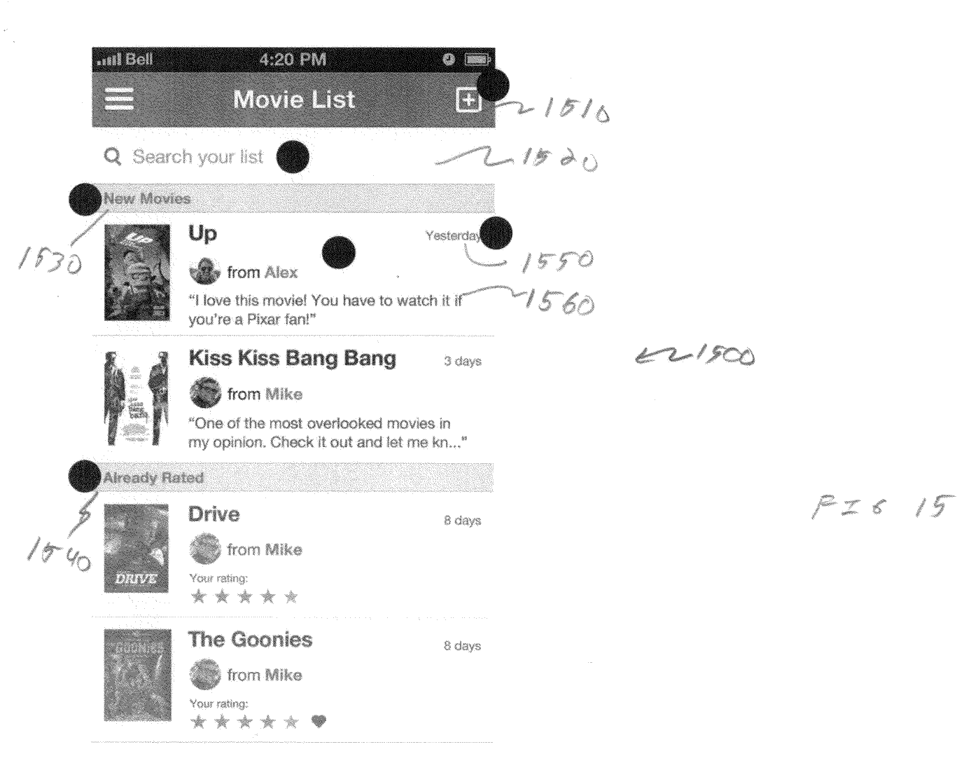

FIG. 14 illustrates an exemplary rate recommendation screen 1400 as described herein. The rate recommendation screen 1400 is displayed after the user selects the “rate” button from the recommendation detail page. The rate recommendation screen 1400 includes a number of stars selection 1410, a submit button 1420, and a cancel button 1430.

To rate the recommendation the user may tap the number of stars representing their rating, the more stars the better. When the submit button 1420 is selected, the user's rating is sent to the recommendation system, and is then displayed along with the recommendation and an indication of the recommendation is sent to the person who sent the recommendation to the user. When the cancel button 1430 is pressed, the recommendation system displays the previous screen.

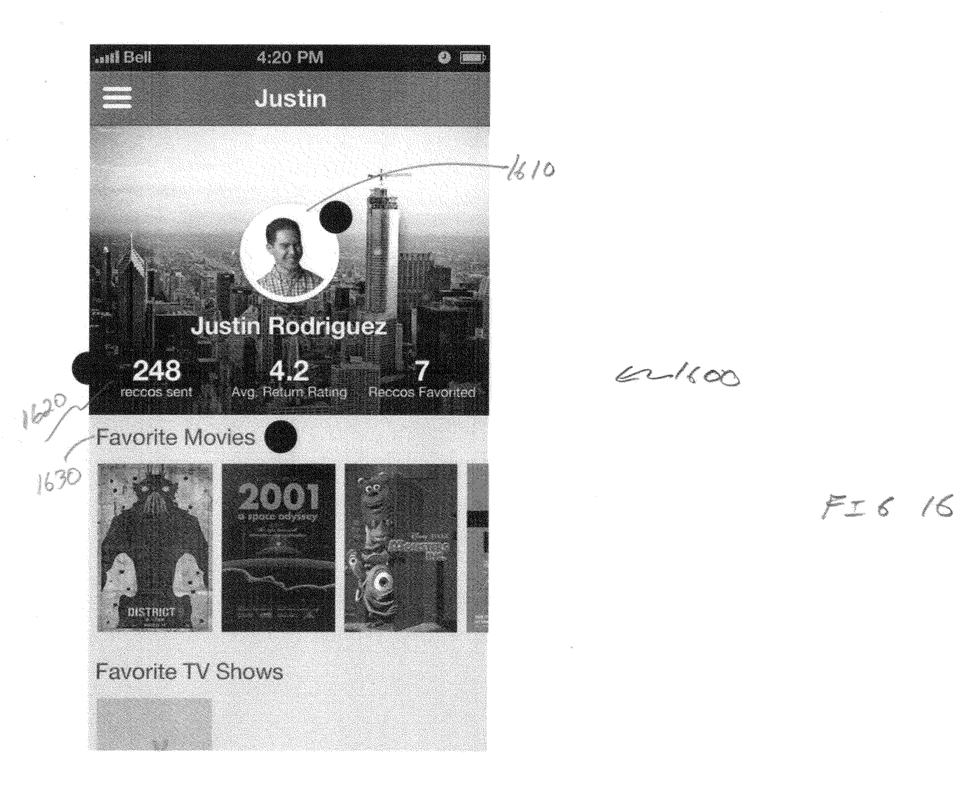

FIG. 15 illustrates an exemplary movie list 1500 as described herein. The movie list is a running list of all of the movies that have either been sent to a user or have been manually added by that user. Items on the list are prioritized smartly based on who is sending that recommendation and what the history of that user sending recommendations to the recipient is, as further described below.

The movie list 1500 includes an add button 1510, a search list 1520, a new movies list 1530, an already rated movies list 1540, a timestamp 1550, and a list item 1560. The add button 1510 allows a user to manually add items to their list. Selecting the add button activates the search movies screen for a user to search for the movie they wish to add to their movies list. The search list 1520 allows a user to search the list of their movies by title or sender, which may be useful when the list of movies is long. The list is automatically filtered based on the text entered in the search list.

The new movies list 1530 displays movies that have not yet been rated by the user, such as recent recommendations. The already rated movies list 1540 displays movies that have already been rated by the user. Timestamp 1550 indicates when the recommendation was sent.

Each list item 1560 shows a photo of the person who sent it to the user, the name of the person who sent it to the user, the title of the item that was sent, and the message if one was included, as well as any rating if the movie has been rated by the user.

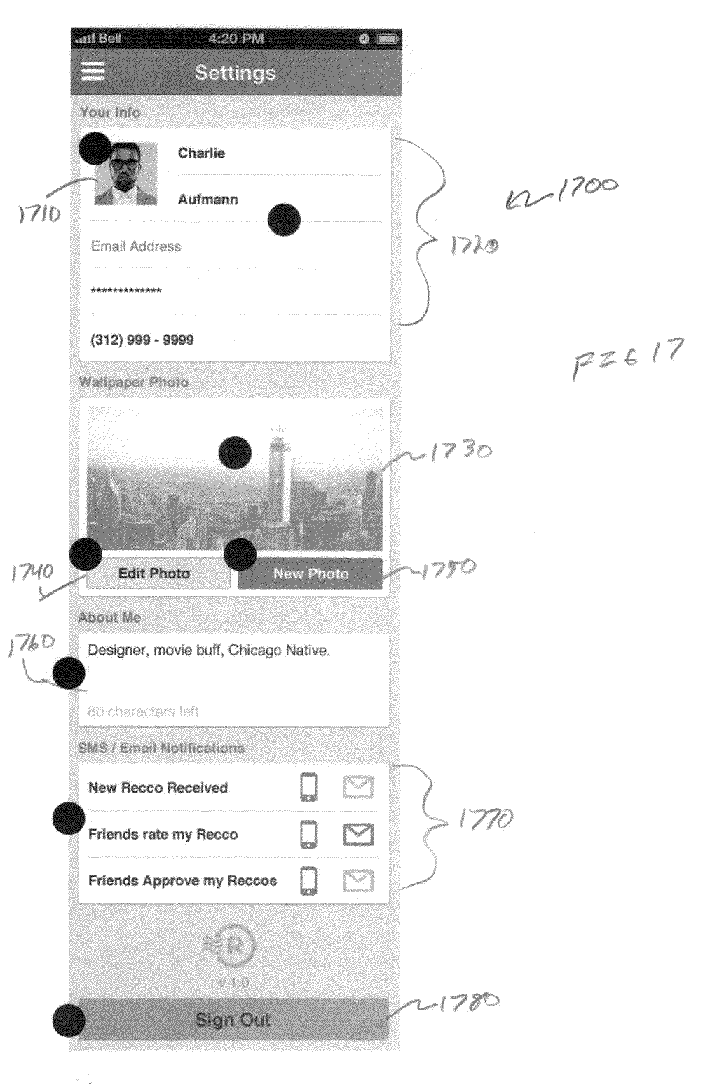

FIG. 16 illustrates an exemplary user profile 1600 as described herein. The user profile 1600 show information and data about a user for that user, or any other user of the recommendation system, to view. The user profile 1600 serves as a quick view of a user's reputation and interests on the recommendation system.

The user profile 1600 includes a user profile photo 1610, user recommendation statistics 1620, and user favorites 1630. As shown in FIG. 16, the user recommendation statistics 1620 may include the number of recommendations sent, the average rating on those recommendations and the number of recommendations that were sent that were subsequently favorite by the recipient. The user favorites 1630 are preferably separated into categories such as movies, TV, books, etc. as described above and represent the items in each category that the user has indicated are the user's favorite. The favorite lists may be sorted and categorized by recommendations type.

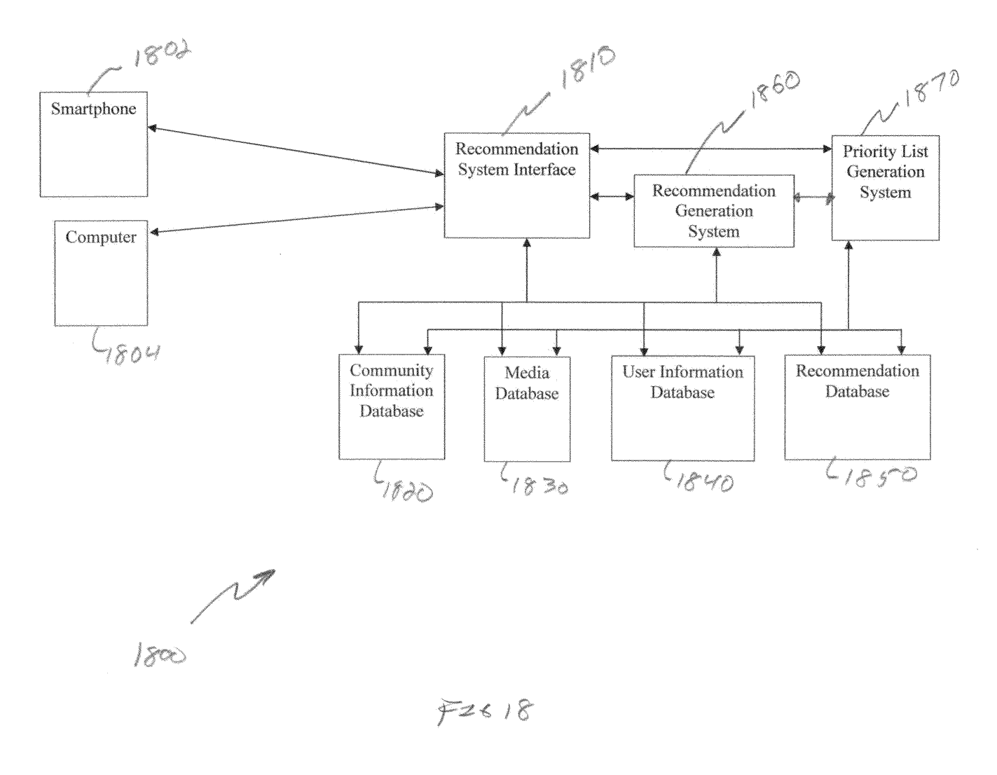

FIG. 17 illustrates an exemplary settings screen 1700 as described herein. The settings screen 1700 provides an interface for users to control their internal recommendation system app settings. For example, a user can change their photo, About Me section of their Profile, and Notification Settings.

The settings screen 1700 includes a user profile photo 1710, user account credentials 1720, profile wallpaper 1730, an edit photo button 1740, an upload new photo button 1750, about me information 1760, notification settings 1770, and a sign out button 1780.

The user account credentials 1720 include the user's first and last names, e0mail address, password, and mobile number. The profile wallpaper 1730 may be edited by a user or new wallpaper may be uploaded. The edit photo button 1740 causes the recommendation system to display editing tools so that the user may edit their profile photo. The upload new photo button 1750 allows a user to upload a new photo.

The about me information 1760 may be a short bio about that user that each user can customize and is displayed in their profile. The notification settings 1770 allow a user to customize how they receive notifications from the recommendation system. For example, the new recommendation received indicator allows a user to set a notification to occur when a new recommendation is received. The user may select that the notification may be sent to the user's smartphone (by pushing on the phone icon) and/or the user's e-mail (by pushing the e-mail icon). The same applies for a notification when a contact rates a recommendation or a contact approves a recommendation.

When the sign out button 1780 is selected, the recommendation system terminates the user's access to the recommendation system.

Sample user scenarios for users of the recommendation system.

User 1—New User Who Discovers the App on their Own

User 1 is reading a tech article that's talking about the recommendation system. Intrigued by the idea, User 1 downloads the recommendation system iPhone app to give it a shot. User 1 is prompted to enter their mobile number to sign on to the application. After entering their mobile number, User 1 gets a text message from the recommendation system with an activation link to log into our system. After clicking the link, User 1 is now signed on to the recommendation system. If they are the first of their friends to have the application, they will not have any recommendations in their Home/Feed. To onboard this new user, User 1 will be prompted to create their first recommendation. User 1 pushes the “New Recco” button, which brings up a menu to select which kind of recommendation they want to send: Movies, Books, Music, Apps, Restaurants, or TV Shows. User 1 selects Movies. After selecting Movies, user 1 is prompted to search for whichever movie they want to recommend. User 1 starts typing “Blade Run . . . ” and Blade Runner appears in a list below automatically based on the user inputting the characters. User 1 selects “Blade Runner” from the list of movie search results. Now the user is prompted to enter whom they are intending to send that movie recommendation to. User 1 starts typing in the name of a friend, “John G . . . ” User 1 selects “John Gillotte” from the list of Contacts we are pulling from their device's Address Book. User 1 has the option of selecting anyone from their address book, including all mobile numbers and email addresses. Now User 1 has the option to add a personal message to John to complete the recommendation and personalize the recommendation. User 1 selects the input field for “Add your personal message.” User 1 types their own personal message to John telling him how much he's going to love this movie. When the personal message is complete, User 1 pushes the “Send” button in the top right of the Applications Navigation Bar. When the send is complete, User 1 is taken back to their Home Screen/Feed Screen where the recommendation he just sent to John is displayed. The recommendation will only be displayed on this screen if John is a current user of the recommendation system. If John is not yet a user on the recommendation system platform, the recommendation User 1 just sent to John will not be displayed for everyone to see until John generates his own account with the recommendation system. However, the recommendation system will send John an SMS or email (depending on the information known about John from User 1's contacts) including a link to the recommendation system site to allow John to set up his own account. Thus, John is a new user who receives a recommendation as described below.

User 2—New User who Receives a Recommendation

User 2 has just received a text message from User 1 saying that User 1 has recommended a movie to them using the recommendation system Application. In that text message is a link to view the recommendation. User 2 pushes the link in their text message, which opens in User 2's mobile browser. The responsive webpage displays the information of the recommendation that User 1 sent to User 2. In this case, it's a recommendation for the movie “Blade Runner.” User 2 may look at all of the information for this movie displayed: Movie title, release date, actors and actresses, ratings from IMDB and Rotten Tomatoes, the movie plot, the director's name, the rating, and the runtime. User 2 also has the ability to watch the trailer for the film, purchase or rent the film on Amazon, or stream/add to their Netflix Queue. The comment that User 1 may or may not have included in their recommendation will also be displayed on this webpage. User 2 will be prompted to rate this recommendation, but if they try to rate it, they will be prompted to download the recommendation system Mobile App and create their account in order to do so. User 2 cannot rate, comment, or perform any other action besides viewing this page unless they are a registered user of the recommendation system. If User 2 keeps receiving multiple recommendations from several friends before they create their account, we will still generate and maintain that user's list until they create their account. User 2 will still be able to view their list of movie recommendations before they create their account. Creating an account gives User 2 the ability to rate recommendations, send recommendations, comment on recommendations, approve recommendations of others, buy products, watch trailers or preview products, etc.

User 3—Power User who has been Using the Recommendation System for a While

User 3 was one of the first users to download and start using our app. They love sharing great things with their friends. The reward for them is the great social connection they receive when one of their friends rates their recommendation 5 stars and adds it to their “Favorites List.” On a weekly basis, User 3 watches a movie, reads a book, goes to a new restaurant, or finds a new great band. Afterwards, he intuitively thinks of a friend of his whom he thinks will enjoy that movie or book or restaurant twice as much as he did. So, he immediately pulls his iPhone out of his pocket and opens the recommendation system application, which is on his Home screen of his iPhone. Once the application launches and it's opened, User 3 pushes the “New Recco” button. Next, User 3 selects a movie. After that, User 3 starts typing the name of whom he wants to send that movie to, selects that person, adds a personal comment, then sends the recommendation. After sending the recommendation, User 3 is brought back to their Home screen where they may see all of the recommendations that he and all of his friends have been sending each other. The Home Screen is a running history/feed of all of the recommendations being sent between all of his contacts on his iPhone.

In one embodiment, the Home/Feed screen serves as the exchange of all of the recommendations a user's community is sharing. User 3 may browse his Home Feed and look through all of the recommendations being sent between his friends. On this Home screen, User 3 may tap into each recommendation to get more details on that recommendation. He may also comment on any of the recommendations on the feed and add his opinions on the recommendation being sent. User 3 may also “Approve” recommendations on the Home Screen. “Approving” recommendations is User 3's way of agreeing with the recommendation. User 3 will approve any recommendation that he believes the recipient will enjoy. “Approving” recommendations also factors into the ranking of that recommendation on a user's list. The more a recommendation is “approved” or agreed upon by the community, the higher on the list that recommendation will go for the recipient of that recommendation.

While User 3 is browsing through the Home Screen, he may also quickly add movies to his Movies List that spark his interest. Each item in the feed will have a menu button. If the menu button is pushed, an action sheet with three options will slide up from the bottom of the device. The three options are “One or more embodiments of the present recommendation system this movie,” “Add this movie to my list,” or “Cancel.” User 3 may quickly recommend this movie to a friend or add this movie to his own movie list.

User 4—Existing User Who gets sent a Notification

User 4 recently signed up for the recommendation system. They know how it works, and they've sent a recommendation before. User 4 is on a different app, say Twitter, browsing through their Twitter feed. User 4 gets a push notification from the recommendation system saying that one of their friends rated one of their recommendations. This is an example of many different notifications a user may receive when their device is active or deactive. Other such notifications are: “User has approved your recommendation,” “User has sent you a new recommendation for ______,” “Your friend has just joined One or more embodiments of the present recommendation system,” or “User has commented on your recommendation.” User 4 opens up the push notification and his iPhone switches from his Twitter app to his recommendation system app. The app immediately brings up the recommendation that their friend just rated. User 4 comments on the recommendation saying he's happy they enjoyed the recommendation.

User 4 decides that he doesn't want to receive push notifications for when a user rates one of his recommendations. Instead he wants to get emails when that happens. So, in order to make this change, User 4 goes to his Settings screen on his recommendation system App. He does this by accessing the main menu, then pushing on the Settings icon. User 4 is now on the settings screen. User 4 scrolls down to notifications settings. User 4 selects that he'd rather have email notifications rather than push notifications when a user rates his recommendation. In this location of the settings section of the app, users have the ability to control how they want to receive notifications—via email or push notification on their phone.

User 4 goes back to their Home Screen where he notices he has some more unread notifications in his Notifications Inbox. The top right section of the Main Navigation Bar on the Home screen contains a Notification icon that tells the user how many unread notifications they have. User 4 pushes on this icon, which brings up his history of notifications—new and old. The top section of this screen shows User 4 the three unread notifications he has. The bottom section shows User 4 all of this older, read notifications. User 4 may push on any of these notifications and be brought to that specific page.

Scoring Methods

In this document we discuss many ways to combine values into scores. The exact combination of functions and weights in a specific implementation may be configurable and chosen based on the parameters set forth below.

Content score for a Particular User

To prioritize the recommendations in a list for the user we calculate a content score for each item and display them in order of their content score. For each content id (CID) in the users recommendation list we calculate the Content Score (CS).

To calculate the content score we aggregate many factors and their weights with suffix W

To form the function to calculate CS to be:

CS=Ag(W1(GlobalRating, GlobalRatingW),

W2(PopularityScore, PopularityScoreW),

W3(FriendsPopularityScore, FriendsPopularityScoreW),

W4(ExpectedRating, ExpectedRatingW),

W5(RecommenderFactor, RecommenderFactorW),

W6(ApproversFactor, ApproversFactorW)) Equation 1

Where Ag is an aggregation function and W1-W6 are weighting functions. Example of Weighting functions—Weighting functions W1-W6 may be used to apply relative weightings to the scores or factors indicated. For example, in one embodiment, the weighting functions may all be equal. In another embodiment, the weighting functions may be used to weight one or more of the scores or factors more heavily than one or more of the other scores or factors. Further, the weighting functions may be predetermined and static, or may be adaptive, for example based on feedback from the user. For example, in one embodiment, it may be determined that content with a high Friends Popularity Score is more often liked or viewed than other content. In this event, the weighting functions may be adjusted so that the Friends Popularity Score is more heavily weighted when determining the Content Score.

Expected Rating

The ability to estimate what a user would rate an item is useful for many features. To calculate the expected rating we leverage ratings from users or external sources which we determine are similar to that user. Determining which ratings source is a good predictor of a user may be accomplished with a Correlation Function. Sources with a high correlation factor may be used as a component in predicting a user's expected rating since they are seemingly correlated.

A User's U bias toward a category compared to another source may be considered a sub factor in calculating an expected rating. To account for this we compute the Users bias toward a category/subcategory. Applying a Signed Bias function (SBF) we define the User Bias Ub as:

User Bias, Ub=SBF(URSet, GRSet) Equation 2

where URSet is the set of User Ratings of the same category and GRSet is the Global Content Ratings for that set of corresponding ratings.

Let us define F_{g} to be the global factor combining the user bias and global content rating (GR) for the item in question F_{g}=(GR, Ub)

For each N in sources calculate it's Rating Source Similarity Factor—Fₙ as described in 1.2.3

Tying this all together gives us the definition of expected rating (ER) to be:

ER=WAgg(F_{g}, F₁, F₂, . . . , Fₙ) Equation 3

Where SRₙ is the rating of Source N, and Wᵣ and W_{cb} are weighting functions and WAgg is a weighted aggregation function.

Signed Bias for a Rating Source

For any set of ratings from a single source we may calculate the Bias of that source as compared to another set of ratings.

Where SR is the set of ratings for items in a category and GR is the set of Global Content Rating (defined in 1.4) for each item to be paired SR.

Applying a Signed Bias function (SBF) we define the bias B as

B=SBF(SR,GR) Equation 4

Rating Similarity Correlation Coefficient

Rating similarity may be measured by calculating a correlation coefficient as described in the Correlation Function section. The way to achieve this would be to use a set of common ratings for items between two data rating sources.

Similarity, S=C(R1,R2) Equation 5

Where C is a Correlation Function and R1 and R2 are sets of ratings from two different sources of the same items.

Rating Source Similarity Factor

For any item that may be rated it's important to be able to quantify the importance of a rating from a source to user. For a rating source ‘N’ it's similarity factor is an attempt to quantify N's rating, bias and similarly, as it relates to a user U. To quantify how important a source's rating is to a user we combine the biases of N and U of the category/subcategory of the item.

Let's define the user bias, Ub=SBF(URSet, GRSet), where URSet is the set of User Ratings of the same category and GRSet is the Global Content Ratings for that set of corresponding ratings. SBF is a signed bias function as described in 1.2.1.

The bias of N, Bₙ=SBF(SRSetₙ, GRSet) the signed bias as described in (1.2.1) Where SRSetₙ is the set of items rated by N in the current category.

Combined Bias, CBₙ=W_{cb}(Ub, Bₙ) which is used in rating normalization.

Similarity of N to User U, Sₙ as described in Rating Similarity (1.2.2) which will be used as a confidence weighting measure.

Combining these factors allows us to define the Rating Source Similarity Factor Fₙ to be the value, weight pair below.

Fₙ.Value=Wᵣ(SRₙ, CBₙ) where SRₙ is the rating for the item from source N

Fₙ.Weight=Sₙ, being the rating Similarity. Equation 6

Global Content Rating

In effort to make our ratings as robust as possible we aggregate ratings from many sources, including our users, external data sources, expert reviewers and so on.

This rating is referred to as the Global Content Rating (GR). To calculate this value we aggregate them with a simple weighted average. For data sources d₁-dₙ we have a corresponding weight w₁-wₙ

GR=Weighted Average([(d₁, w₁), (d₂, w₂) . . . (dₙ, wₙ)]) Equation 7

Popularity Score

In one embodiment, we store recommendation activity data in a tabular database. There is a record for each type of action users may take regarding a recommendation, including “Approved”, “Rated”, “Commented On”, and “Recommended”. Data fields included in this database for each action are: Recommended Content Id (CID)—Unique Identifier for each recommendable item; Categories—An array of subcategories and hierarchy paths for this CID; UserId—Unique Identifier for each user; and Time—When the action occurred

Generalized Popularity Score

To calculate a popularity score we calculate the counts of each type of record for each CID in the given set of interest. These counts are named—ApprovedCount, RatedCount, CommentedCount and RecommendedCount for the corresponding actions. Each of these metrics is combined with their predefined weights as shown with the suffix W. When we combine these values we calculate the popularity value—Pv.

Pv=Ag(W1(ApprovedCount, ApprovedCountW),

W2(RatedCount, RatedCountW),

W3(CommentedCount, CommentedCountW),

W4(RecommendedCount, RecommendedCountW)) Equation 8

Where Ag is an aggregation function and W1-4 are weighting functions.

For each CID in the set we order them by their Pv. Then the popularity score (PS) for each CID is defined as the percentile ranking of that CID, creating a range of [1-0] for the PS. Where 1 is most popular item and 0 is the least.

Friend Popularity Score

Friend Popularity Score (FPS) is defined as the same value above (PS) but filtered to actions of friends in your contact list.

Category/Subcategory Popularity Score

A category or subcategory popularity score (CPS) may be calculated by doing a partial or full match on the hierarchy paths. CPS=Generalized Popularity Score with the set of actions that match a hierarchy category specified.

Friend Popularity Score for a Category

Friend Category Popularity Score (FCPS) is defined as the same value (CPS) above but filtered to actions of friends in your contact list.

Friend's Content Score Factor

A friend's content score factor is a measure of two user's interaction, biases, reputation and the friends rating for a recommendable item. In one embodiment, it may be used as a factor in being able to organize recommendations.

For a user U, friend F and a recommendable item, F's content score factor is a value for U's content score we calculate the Friends Content Score Factor with these factors. F's Item Score—Defined as using F's Ratings Source Similarity factor (1.2.3) as Fn we combine Fn.Value and Fn.Weight into a single value with Wfn a weighting function Wfn(Fn.Value, Fn.Weight) into a single value FItemScore

F's Return Rating From U—FretRating

U's Return Rating From F—UretRating

Total Recommendations F Sent To U—Fsent

Total Recommendations F Received From U—Frecieved

Approvals F Sent—ApprovesF

Approvals U Sent—ApprovesU

U Favorites F Sent—FavsU

F Favorites U Sent—FavsF

Total Other Interactions—OtherCount

Other interactions included commenting on each other recommendations and forwarding of recommendations.

Each of these metrics is combined with their predefined weights as shown with the suffix W. When we combine these values we calculate the Friends Content Score Factor FCSF.

FCSF=Ag(W1(FItemScore, FItemScoreW),

W2(FRetRating, FRetRatingW),

W3(URetRating, URetRatingW),

W4(FSent, FSentW),

W5(ApprovesF, ApprovesFW),

W6(ApprovesU, ApprovesUW),

W7(FavsU, FavsUW),

W8(FavsF, FavsFW),

W9(OtherCount, OtherCountW)) Equation 9

Where Ag is an aggregation function and W1-W9 are weighting functions. Additionally, the weighting functions W1-W9 may be predetermined or adjustable as described above.

Recommender's Content Score Factor

Using the method described in 1.5 the person who sent the recommendation is calculated a friend content score factor. This value along with a weight is used directly in the content score.

In the case that the recommender has no rating for this recommended item we calculate the recommenders Expected Rating (1.2) and use that instead.

Approver's Content Score Factor

In some instances, multiple people approve a recommendation. For this to factor into the content score in one embodiment we take the list of all users who approved the recommendation A of length N.

For each user in A we apply the Friend Content Score Factor and store it into F1,F2, . . . , Fn respectively.

In the case that the Approver has no rating for this recommended item we shall calculate the approver Expected Rating (1.2) and use that instead.

These factors allow us to calculate the Approvers Content Score Factor—ACSF

ACSF=Ag(F1,F2, . . . , Fn) Equation 10

where Ag is an aggregation function.

Function Definitions

Weighting Functions

A weighting function is a mathematical function to transform an input value with a predetermined weight value with the purpose of allowing its value to have more or less influence when aggregated with other factors. Our weighting functions used are Monotonic Functions (http://en.wikipedia.org/wiki/Monotonic_function) and may be of linear, exponential, polynomial, logarithmic transformations.

Here are some examples of several embodiments of W(v,w) functions, v being the input value, and w being the weight

$$Linear ( v , w ) = v * w \\ Linear ( v , w ) = 5 * v + w \\ Exponential ( v , w ) = {w}^{V} \\ Polynominal ( v , w ) = w * {v}^{2} \\ Logarithmic ( v , w ) = {log}_{w} v \\ Sigmoid ( v , w ) = \frac{w}{( 1 - {e}^{- V} )} \qquad Equation 11$$

Aggregation Functions

An Aggregation function is a function that combines a set of values into a single value. A sample of some of the well-known aggregation functions some are listed below.

Examples—where ‘s’ is the input set and is of set length n.

Sum(s): Computes the sum of all elements

Max(s): Computes the maximum value of all elements

Min(s): Computes the minimum value of all elements

Product(s): Computes the product of all elements πᵢ₌₀ⁿ⁻¹s[i]

Count(s): returns the length of the set in this example n

Average(s): computes the arithmetic mean of the set

Weighted Aggregation Function

A weighted Aggregation function fundamentally takes in a list of values and weights (factors) aggregates them then combines that value with the aggregated weights. An example of a weighted aggregation function is a weighted average function.

Let us define a factor F as being a Value and a Weight pair (V,W) then a Weighted Aggregation function takes in a set of factors. Then the generic form of a weighted aggregation function is as follows:

WAF(F[1 . . . n])=W_{af}(A_{f}, A_{w}) Equation 12

Where Aggregated Factors, A_{f} and Aggregated Weights A_{w} are defined as:

A_{f}=Ag_{f}(W₁(F₁.V, F₁.W), W₂(F₂.V, F₂.W), . . . Wₙ(Fₙ.V, Fₙ.W))

A_{w}=Ag_{w}(F₁.W, F₂.W, . . . Fₙ.W)

W_{af}, W₁−Wₙ are weighting functions and Ag_{f} and Ag_{w} are aggregation functions. Equation 13

Bias Functions

In order to calculate the bias or preferences of a user we may calculate a bias value by statistically comparing the ratings of that user/individual U to another known set A of ratings we wish to measure the bias between.

If we treat U as the prediction set and A as the truth set we may compute a range of well-known statistical functions—Mean Cubed Error, Mean Squared Error, Mean Absolute Error, Mean Root Error and Mean Absolute Scaled Error, with a small modification.

Signed Bias Functions

A signed bias function is a bias function that preserves the sign of the difference between the prediction set and the truth set. To take the MSE function as an example,

$$MSE = \frac{1}{n} {Σ ( U - A )}^{2}$$

and the sign difference between U-A is lost in the squared function. Whereas the signed MSE is

$$SMSE = \frac{1}{n} Σ ( sign ( U - A ) * {( U - A )}^{2} ) \qquad Equation 14$$

And SMSE it preserves the sign difference.

Where sign returns 1 if given positive number and −1 if negative

Correlation Functions

Correlation of datasets may be calculated by using a statistical method to calculate the correlation coefficient. Such methods may include the Pearson product-moment correlation coefficient, Spearman's rank correlation coefficient and intraclass correlation coefficient. These functions generally return a 1 for things perfectly correlated, and −1 for with an anti-correlation relationship.

Other Notes

Taxonomy of Recommendable Items

In one embodiment, recommendable items are stored with a unique identifier and have associated with it a hierarchy path for attributes associated with the item. This taxonomy allows us to identify similar items, to calculate user biases and also determine which users are subject matter experts in certain categories. For example, a user may be identified as a subject matter expert when the user's recommendation is passed to many other users and the other users act on the recommendation.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. A computerized system for recommendation delivery and tracking.
